(19) United States
(12) Patent Application Publication
(10) Pub. No.: US 2026/0126858 A1
(43) Pub. Date: May 7, 2026

(54) SYSTEMS AND DEVICES FOR GENERATING AND OUTPUTTING COMBINED HEARTBEAT SIMULATION PATTERNS AND METHODS THEREOF

(71) Applicant: Moonbow Innovations Inc., Carrollton, TX (US)

(72) Inventors: Juan Vasquez, Carrollton, TX (US); Mara Drazina, Lipan, TX (US)

(73) Assignee: Moonbow Innovations Inc., Carrollton, TX (US)

(21) Appl. No.: 19/439,289

(22) Filed: Jan. 2, 2026

Related U.S. Application Data
(63) Continuation-in-part of application No. 19/089,920, filed on Mar. 25, 2025.
Application No. 19/089,920 is a division of application No. 18/315,763, filed on May 11, 2023, now Pat. No. 12,265,662.
(60) Provisional application No. 63/347,953, filed on Jun. 1, 2022.

(51) Int. Cl. G06F 3/01; G06F 3/16

(52) U.S. Cl. CPC G06F 3/016; G06F 3/16

(57) ABSTRACT

Systems, devices, and methods for generating and outputting combined heartbeat simulation patterns using one or more heartbeat simulation devices. In embodiments, a first heartbeat pattern and a second heartbeat pattern are obtained from one or more sources, including heartbeat simulation devices, user devices, storage locations, or backend servers. Upon satisfaction of a combination condition, such as proximity detection, physical attachment detection, or user-initiated selection, a combined heartbeat pattern is generated using one or more algorithmic combination techniques. The combined heartbeat pattern may be stored, transmitted, or output by one or more heartbeat simulation devices. In embodiments, the combined heartbeat pattern may be output by a single heartbeat simulation device, by a plurality of heartbeat simulation devices concurrently, or by a plurality of heartbeat simulation devices in a coordinated manner in which different portions of the combined heartbeat pattern are output by different heartbeat simulation devices.

### TECHNICAL FIELD

The present disclosure generally relates to heartbeat simulation devices, and more specifically to devices configured for generating and reproducing combined heartbeat simulation patterns.

### BACKGROUND

Heartbeat patterns have long been recognized as meaningful physiological signals that convey information beyond mere biological function. A heartbeat pattern may reflect rhythm, variability, intensity, and timing characteristics that are unique to an individual. As a result, heartbeat patterns have been used in a variety of contexts, including medical monitoring, biometric identification, wellness applications, and personal or emotional expression. In some non-medical contexts, heartbeat patterns have been recorded and reproduced to create a sense of presence, connection, or reassurance.

Conventional systems for reproducing heartbeat patterns typically rely on static playback mechanisms. For example, a recorded heartbeat waveform may be replayed using an audio speaker or a vibration motor to simulate a pulse. While such approaches may reproduce a single heartbeat pattern, they are generally limited to isolated playback of prerecorded data and lack the ability to dynamically generate new heartbeat patterns based on interaction between multiple heartbeat sources. In many cases, such systems are constrained to a single device and a single output modality, such as vibration or sound, and do not support coordinated or multi-device output.

Additionally, existing approaches generally do not provide mechanisms for combining heartbeat patterns from multiple individuals into a unified or composite heartbeat pattern. When multiple heartbeat signals are involved, conventional systems may simply alternate playback. Another limitation of existing systems is the lack of coordinated output across multiple devices. Even where multiple devices are capable of reproducing heartbeat patterns, there is typically no mechanism to ensure that such devices generate a shared or coordinated heartbeat simulation. As a result, playback across devices may be unsynchronized, redundant, or inconsistent.

Furthermore, conventional heartbeat reproduction systems often treat heartbeat output as a fixed signal rather than as a pattern that may be transformed, partitioned, or rendered differently depending on context. This limits the ability to support advanced output configurations.

### SUMMARY

The present disclosure achieves technical advantages as systems, devices, and methods configured to generate, combine, and output simulated heartbeat patterns using one or more heartbeat simulation devices. In embodiments, a plurality of heartbeat simulation devices may be configured to store individual heartbeat patterns and to interact with one another to generate a combined heartbeat pattern that reflects characteristics of two or more source heartbeat patterns. By enabling automated generation and output of combined heartbeat patterns in response to interaction events, such as proximity detection, physical attachment, and/or user-initiated selection, the disclosed systems provide a mechanism for producing unified heartbeat simulations that may be experienced tactilely, audibly, or both, without requiring manual synchronization or static pre-recorded playback.

In particular embodiments, the system may be configured to generate the combined heartbeat pattern using one or more algorithmic combination techniques, including mathematical superposition, interleaving, feature blending, modulation, and AI-based pattern generation. The combined heartbeat pattern may be generated locally by a heartbeat simulation device, by a user device executing a companion software application, by a backend server, or by combinations thereof. The combined heartbeat pattern may be caused to be output by a single heartbeat simulation device, by a plurality of heartbeat simulation devices concurrently, or by a plurality of heartbeat simulation devices in a coordinated manner in which different portions of the combined heartbeat pattern are output by different heartbeat simulation devices, such as in response to detecting a user interaction with the device. This flexibility allows the system to support a wide range of interaction and output configurations without constraining the simulation to a single device or modality.

In embodiments, the heartbeat simulation devices may be configured to operate in multiple operational modes, including individual modes, temporary combined modes, and synchronized combined modes. In temporary combined modes, the combined heartbeat pattern may be generated and output (such as in response to detecting a user interaction or automatically) only while an interaction condition persists, such as during proximity or physical attachment. In synchronized combined modes, the combined heartbeat pattern may be stored and persist across separation events, allowing the combined heartbeat simulation to continue to be output (such as in response to detecting a user interaction or automatically) even when the heartbeat simulation devices are no longer physically connected. The ability to dynamically transition between modes and to persist or discard combined heartbeat patterns based on configuration provides robust control over how simulated heartbeat patterns are generated, stored, and experienced.

Thus, it will be appreciated that the technological solutions provided herein, and missing from conventional systems, include more than a mere playback of prerecorded heartbeat signals and instead provide a distributed, interactive, and algorithmically driven system for simulating combined heartbeat patterns across one or more devices. The present disclosure provides a technological solution that overcomes limitations associated with isolated or unsynchronized heartbeat reproduction by enabling coordinated generation, transformation, and output of heartbeat simulations across multiple devices and processing environments. The claims herein therefore provide a technological solution that improves the operation of heartbeat simulation systems by enabling dynamic, multi-device, and multi-modal heartbeat simulation that adapts to user interaction and device configuration.

In embodiments, output of a combined heartbeat pattern is not merely a presentation of information, but may include automatic physical actuation of one or more physical output components of a heartbeat simulation device. In embodiments, once a combined heartbeat pattern is generated, the heartbeat simulation device may be configured to automatically generate one or more control signals corresponding to timing, intensity, and/or sequence characteristics of the combined heartbeat pattern. In embodiments, the control signals may be transmitted to a physical output component, such as a tactile output generator, electromechanical actuator, vibration motor, linear resonant actuator, solenoid, and/or other force-producing component.

In embodiments, the control signals may cause the physical output component to actuate in a manner that produces a tangible, physically perceptible heartbeat simulation, including discrete pulses, beats, or rhythmic forces corresponding to the combined heartbeat pattern. In embodiments, the physical actuation may include movement, vibration, pressure application, and/or mechanical displacement that may be felt by a user when interacting with the heartbeat simulation device. In embodiments, generation and transmission of the control signals may occur automatically without user intervention, and may be triggered in response to detection of a user interaction event (e.g., wrapping their hand around the device, pressing the device against a body part, etc.), generation of the combined heartbeat pattern, and/or entry into a particular operational mode.

In embodiments, the use of control signals to actuate physical output components integrates heartbeat pattern generation into a practical application by directly controlling real-world hardware to produce a physical effect. In embodiments, the heartbeat simulation device may use heartbeat pattern data to control physical behavior of the device itself, rather than merely displaying or outputting information. This physical actuation distinguishes the heartbeat simulation process from abstract data processing and enables automatic, tangible heartbeat simulation using electromechanical components of the heartbeat simulation device.

It is an object of the disclosure to provide a system for generating and outputting a combined heartbeat pattern. It is a further object of the disclosure to provide a heartbeat simulation device, and a method for combining heartbeat patterns associated with two or more heartbeat simulation devices. These and other objects are provided by the present disclosure, including at least the following embodiments.

In one particular embodiment, a system for generating and outputting a combined heartbeat pattern is provided. The system includes a first heartbeat simulation device comprising a first output generator configured to output a heartbeat pattern, a second heartbeat simulation device comprising a second output generator configured to output a heartbeat pattern, and a communication arrangement configured to enable communication between the first heartbeat simulation device and the second heartbeat simulation device. In embodiments, at least one of the first heartbeat simulation device and the heartbeat simulation device is configured to detect an interaction event between the first heartbeat simulation device and the second heartbeat simulation device, to generate, in response to the interaction event, a combined heartbeat pattern based on at least the first heartbeat pattern and the second heartbeat pattern, and to cause output of the combined heartbeat pattern using one or more of the first output generator and the second output generator.

In another embodiment, a heartbeat simulation device is provided. The heartbeat simulation device includes at least one processor and a memory operably coupled to the at least one processor, a communication module configured to communicate with at least one additional heartbeat simulation device and a tactile output generator configured to reproduce a heartbeat pattern. In embodiments, the memory is further configured to store processor-readable code that, when executed by the at least one processor, is configured to perform operations. The operations include generating a combined heartbeat pattern based on a heartbeat pattern stored in the memory and a heartbeat pattern received from the additional heartbeat simulation device.

In still another embodiment, a method for combining heartbeat patterns associated with two or more heartbeat simulation devices is provided. The method includes obtaining a first heartbeat pattern from a first source and obtaining a second heartbeat pattern from a second source. In embodiments, at least one of the first source or the second source includes one or more of a user device, a heartbeat simulation device, a storage location, and a backend server. The method also includes determining that a combination condition has been satisfied, the combination condition including one or more of proximity detection between heartbeat simulation devices, physical attachment detection between heartbeat simulation devices, and user-initiated selection via a companion software application, generating a combined heartbeat pattern using at least one algorithmic combination technique applied to the first heartbeat pattern and the second heartbeat pattern, and causing the combined heartbeat pattern to be stored, transmitted, or output by one or more heartbeat simulation devices. In embodiments, the combined heartbeat pattern is caused to be output by a single heartbeat simulation device, by a plurality of heartbeat simulation devices concurrently, or by a plurality of heartbeat simulation devices in a coordinated manner in which different portions of the combined heartbeat pattern are output by different heartbeat simulation devices.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a diagram of a heartbeat and melody system configured with functionality for combined operations in accordance with embodiments of the present disclosure.

FIG. 2 is a diagram of a heartbeat simulation device configured with functionality for combined operations in accordance with embodiments of the present disclosure.

FIG. 3 is a diagram illustrating functionality for implementing combined operations of one or more heartbeat simulation devices in accordance with embodiments of the present disclosure.

FIG. 4 is a diagram illustrating functionality for implementing combined operations of one or more physically attached heartbeat simulation devices in accordance with embodiments of the present disclosure.

FIG. 5 is a block diagram illustrating an operational mode for the heartbeat simulation devices in accordance with embodiments of the present disclosure.

FIG. 6 is a flow diagram illustrating various embodiments for initiation and processing of heartbeat pattern combination within the combined heartbeat and melody system in accordance with embodiments of the present disclosure.

FIG. 7 is an algorithmic diagram illustrating multiple embodiments of heartbeat pattern combination techniques that may be employed by the combined heartbeat and melody system in accordance with embodiments of the present disclosure.

FIG. 8 is a flow diagram illustrating an embodiment of a process for converting a heartbeat pattern into a musical melody within the combined heartbeat and melody system in accordance with embodiments of the present disclosure.

FIG. 9 is an algorithmic diagram illustrating multiple embodiments of melody generation techniques that may be employed to generate a musical melody from a heartbeat pattern within the combined heartbeat and melody system in accordance with embodiments of the present disclosure.

FIG. 10 is a functional block diagram illustrating an embodiment of a companion software application executable on a user device in accordance with embodiments of the present disclosure.

FIG. 11 is a schematic diagram illustrating embodiments for output and export pathways associated with heartbeat patterns and generated melodies within the combined heartbeat and melody system in accordance with embodiments of the present disclosure.

FIG. 12 is a diagram illustrating embodiments for memory management and synchronization within the combined heartbeat and melody system in accordance with embodiments of the present disclosure.

FIG. 13 is a state transition diagram illustrating embodiments of attachment and separation state transitions for heartbeat simulation devices within the combined heartbeat and melody system in accordance with embodiments of the present disclosure.

FIG. 14 shows a high-level flow diagram of operations of a method for combining heartbeat patterns associated with two or more heartbeat simulation devices in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, as evidenced by issuance of this patent, the prior art fails to disclose or teach the elements and limitations presented in the claims as enabled by the specification and drawings, such that the presented claims are patentable under the applicable laws and rules of this jurisdiction.

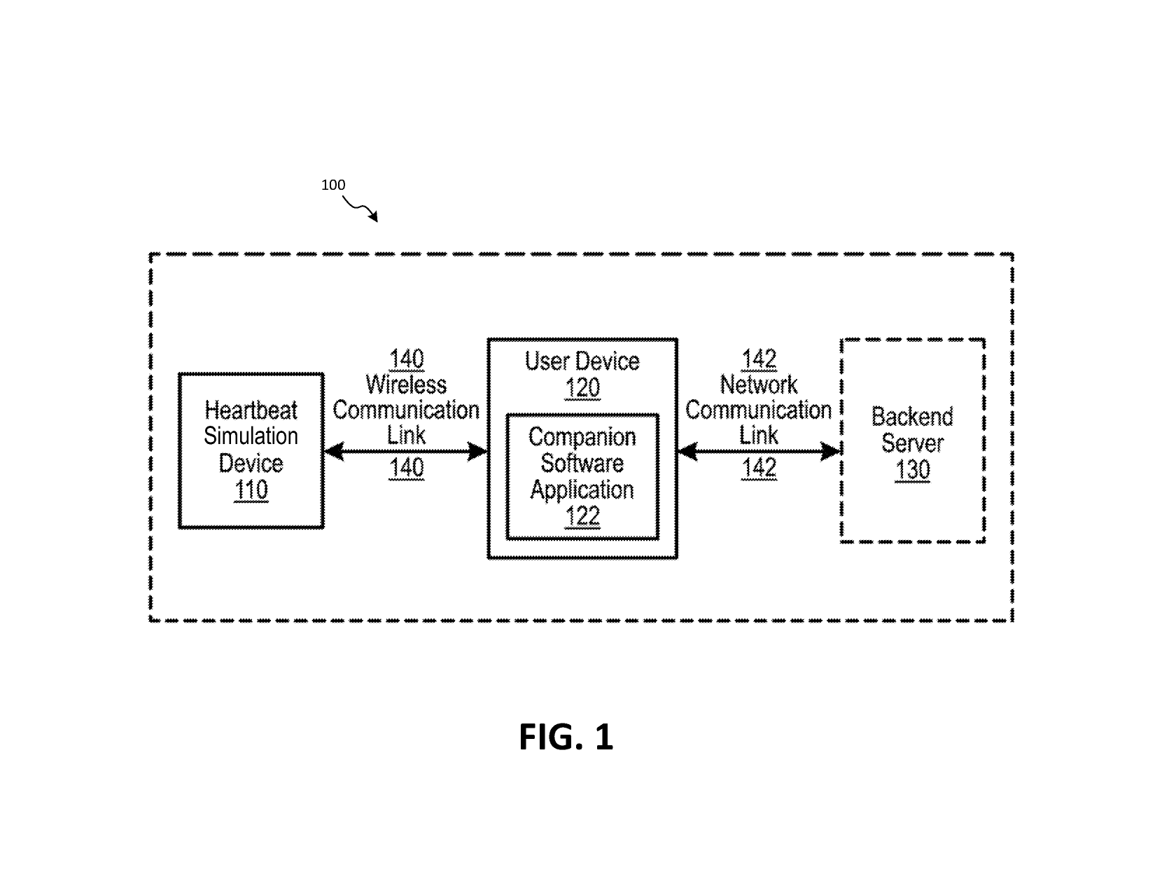

FIG. 1 is a diagram of a heartbeat and melody system 100 configured with functionality for combined operations in accordance with embodiments of the present disclosure. In particular, the combined heartbeat and melody system 100 may be configured to capture, store, combine, transform, and/or output one or more heartbeat patterns, including output as a tactile heartbeat representation and/or output as an audible melody representation derived from a heartbeat pattern. In embodiments, the combined heartbeat and melody system 100 may be configured to operate using one wearable device or a plurality of wearable devices, and may further be configured to operate with or without network connectivity depending on implementation.

In embodiments, the combined heartbeat and melody system 100 may include one or more heartbeat simulation devices 110, a user device 120, a companion software application 122 executable on the user device 120, and an optional backend server 130. In embodiments, these components may cooperate to provide the functionality described herein. In embodiments, any one component may provide a subset of the overall functionality, and in embodiments multiple components may redundantly provide overlapping functionality, such as pattern storage, pattern generation, playback control, etc. to avoid restricting the disclosure to a single locus of processing.

In embodiments, the heartbeat simulation device 110 may include a heartbeat simulation device that may be configured to generate, render, and/or otherwise simulate a heartbeat pattern based on stored heartbeat data, combined heartbeat data, heartbeat pattern data, and/or algorithmically generated heartbeat data. In embodiments, the heartbeat simulation device may output the simulated heartbeat pattern using tactile output, audio output, visual output, or combinations thereof. The outputted simulated heartbeat pattern may be felt or otherwise perceived by the user when interacting with the heartbeat simulation device (e.g., by wrapping their hand around the heartbeat simulation device, pressing the heartbeat simulation device against a body part, such as their chest, etc.). In embodiments, the heartbeat simulation device may be implemented in a wearable or non-wearable form factor, including but not limited to necklaces, pendants, bracelets, keychains, rings, or other personal devices.

In embodiments, once a combined heartbeat pattern has been generated, the combined heartbeat pattern may be caused to be output in a variety of output configurations involving one or more heartbeat simulation devices. In embodiments, the combined heartbeat pattern may be caused to be output by a single heartbeat simulation device, such that the entirety of the combined heartbeat pattern is rendered by a single heartbeat simulation device using one or more output generators associated with that heartbeat simulation device. In such embodiments, the single heartbeat simulation device may output the combined heartbeat pattern as a tactile heartbeat simulation, an audible heartbeat-derived melody, or a combination thereof, independent of whether additional heartbeat simulation devices are present or active.

In embodiments, the combined heartbeat pattern may be caused to be output by a plurality of heartbeat simulation devices concurrently. In such embodiments, two or more heartbeat simulation devices may each output the combined heartbeat pattern substantially at the same time. In embodiments, concurrent output may involve each heartbeat simulation device outputting an identical representation of the combined heartbeat pattern. In embodiments, concurrent output may be synchronized using timing information exchanged between the heartbeat simulation devices, timing information provided by a user device executing a companion software application, and/or timing information derived from a shared clock or synchronization signal. In embodiments, concurrent output may be used to create a shared or mirrored heartbeat simulation experience across multiple heartbeat simulation devices.

In embodiments, the combined heartbeat pattern may be caused to be output by a plurality of heartbeat simulation devices in a coordinated manner in which different portions of the combined heartbeat pattern are output by different heartbeat simulation devices. In such embodiments, the combined heartbeat pattern may be logically partitioned into segments, phases, beats, sub-patterns, waveform components, and/or other portions. In embodiments, a first heartbeat simulation device may be configured to output a first portion of the combined heartbeat pattern, while a second heartbeat simulation device may be configured to output a second portion of the combined heartbeat pattern. In embodiments, the different portions may be output sequentially, alternately, interleaved, and/or according to a predefined or dynamically determined coordination scheme.

In embodiments, coordinated output may include embodiments in which one heartbeat simulation device outputs a first heartbeat component derived predominantly from a first heartbeat pattern, while another heartbeat simulation device outputs a second heartbeat component derived predominantly from a second heartbeat pattern, such that the combined heartbeat pattern is perceptible across the plurality of heartbeat simulation devices as a unified simulation. In embodiments, coordinated output may further include embodiments in which different heartbeat simulation devices output different modalities of the combined heartbeat pattern, such as one heartbeat simulation device outputting a tactile heartbeat simulation while another heartbeat simulation device outputs an audible representation derived from the same combined heartbeat pattern.

In embodiments, coordination of output among multiple heartbeat simulation devices may be managed by at least one of the heartbeat simulation devices themselves, by a user device executing a companion software application, and/or by a backend server. In embodiments, coordination may involve exchange of control signals, timing information, identifiers corresponding to portions of the combined heartbeat pattern, and/or metadata describing how the combined heartbeat pattern is to be partitioned and output. In embodiments, the coordination scheme may be predetermined, user-configurable, or dynamically selected based on operational mode, proximity, physical attachment, or other interaction conditions.

In embodiments, the ability to output the combined heartbeat pattern by a single heartbeat simulation device, by multiple heartbeat simulation devices concurrently, and/or by multiple heartbeat simulation devices in a coordinated and partitioned manner provides significant flexibility in how combined heartbeat simulations are experienced. In embodiments, such flexibility allows the combined heartbeat pattern to be expressed as a unified simulation even when output responsibilities are distributed across multiple heartbeat simulation devices, without limiting the combined heartbeat pattern to a particular output modality, timing relationship, and/or device configuration.

In embodiments, the heartbeat simulation device 110 may be a wearable electronic device configured to be worn on a person, such as on a chain, cord, and/or other wearable support structure. In embodiments, the heartbeat simulation device 110 may include a housing, which may be configured as a pendant, charm, keychain, locket, and/or other form factor suitable for wearing. In embodiments, the heartbeat simulation device 110 may be configured to store one or more heartbeat patterns locally, to reproduce a heartbeat pattern as a tactile output, and/or to reproduce a heartbeat-derived melody as an audio output. In embodiments, the heartbeat simulation device 110 may be configured as a self-contained device capable of performing one or more operations without continuous reliance on the user device 120 or the backend server 130.

In embodiments, the heartbeat simulation device 110 may be configured to store an individual heartbeat pattern associated with a first user, and in embodiments the heartbeat simulation device 110 may be configured to store a plurality of heartbeat patterns associated with a plurality of persons. In embodiments, the heartbeat simulation device 110 may be configured to store one or more combined heartbeat patterns generated from two or more individual heartbeat patterns. In embodiments, the heartbeat simulation device 110 may be configured to output an individual heartbeat pattern in a first mode and output a combined heartbeat pattern in a second mode, and may be configured to transition between such modes automatically or in response to user control signals.

In embodiments, the heartbeat simulation device 110 may be configured to receive, over a wireless or wired connection, heartbeat pattern data and melody data generated by the companion software application 122. In embodiments, the heartbeat simulation device 110 may be configured to generate a combined heartbeat pattern locally (e.g., without relying on the companion software application 122) from two or more heartbeat patterns. In embodiments, the heartbeat simulation device 110 may be configured to convert a heartbeat pattern into a melody locally and to play such melody locally. In embodiments, the heartbeat simulation device 110 may be configured to cooperate with another heartbeat simulation device 110 to enable proximity-based interaction, attachment-based interaction, or both.

In embodiments, the companion software application 122 may be configured to generate a combined heartbeat pattern from two or more heartbeat patterns, and/or to convert a heartbeat pattern into a melody, and to transmit the combined heartbeat pattern and/or the melody to the heartbeat simulation device 110 for reproduction (e.g., to reproduce or simulate the combined heartbeat pattern and/or to play the melody).

In embodiments, the user device 120 may be a smartphone, tablet, laptop, wearable computing device, and/or other computing device configured to execute the companion software application 122. In embodiments, the user device 120 may provide a user interface configured to allow a user to interact with the combined heartbeat and melody system 100. In embodiments, the user device 120 may provide processing resources, storage resources, connectivity resources, or a combination thereof, which may be utilized by the companion software application 122 to implement the functionality described herein.

In embodiments, the user device 120 may be configured to communicate with the heartbeat simulation device 110 via the wireless communication link 140, and/or in some embodiments the communication between the user device 120 and the heartbeat simulation device 110 may be via a wired connection. In embodiments, the wireless communication link 140 may include Bluetooth, Bluetooth Low Energy, Wi-Fi, a proprietary wireless protocol, and/or another wireless communication protocol. In embodiments, the wireless communication link 140 may be configured to carry heartbeat pattern data, melody data, configuration data, device status data, control commands, and/or combinations thereof between the user device 120 and the heartbeat simulation device 110.

In embodiments, the user device 120 may be configured to communicate with the backend server 130 via the network communication link 142. In embodiments, the network communication link 142 may include one or more networks, including the internet, a cellular network, a local area network, or combinations thereof. In embodiments, the user device 120 may be configured to transmit heartbeat pattern data, combined heartbeat pattern data, melody data, account authentication data, configuration data, and/or other data between the companion software application 122 and the backend server 130.

In embodiments, the heartbeat simulation device 110 may be configured to communicate with the backend server 130 via a network communication link including one or more networks, including the internet, a cellular network, a local area network, or combinations thereof. In embodiments, the heartbeat simulation device 110 may be configured to receive and/or transmit heartbeat pattern data, combined heartbeat pattern data, melody data, account authentication data, configuration data, device status data, control commands, and/or other data between the companion software application 122 and the backend server 130

In embodiments, the companion software application 122 may be executable on the user device 120 and may be configured to provide an interface for managing heartbeat patterns and melodies associated with the combined heartbeat and melody system 100. In embodiments, the companion software application 122 may be configured to capture heartbeat patterns, import heartbeat patterns, store heartbeat patterns, name heartbeat patterns, organize heartbeat patterns, and synchronize heartbeat patterns with the heartbeat simulation device 110. In embodiments, the companion software application 122 may be configured to generate combined heartbeat patterns from two or more heartbeat patterns. In embodiments, the companion software application 122 may be configured to generate a melody from a heartbeat pattern and to provide customization settings for such melody generation.

In embodiments, the companion software application 122 may be configured to determine how and where certain processing is performed. For example, in embodiments, the companion software application 122 may be configured to perform combination processing locally on the user device 120, to instruct the heartbeat simulation device 110 to perform combination processing locally, and/or to request the backend server 130 to perform combination processing remotely and return results. In embodiments, the companion software application 122 may be configured to push generated heartbeat pattern data or generated melody data to the heartbeat simulation device 110 for local storage and playback (e.g., to be output or reproduced by the device).

In embodiments, the companion software application 122 may be configured to control operating modes of the heartbeat simulation device 110. For example, in embodiments, the companion software application 122 may be configured to select whether a dual-pendant configuration, when attached, operates in a temporary combined mode or a synchronized combined mode, and may be configured to communicate such mode selection to the heartbeat simulation device 110 over the wireless communication link 140.

In embodiments, the backend server 130 may be a cloud server, distributed computing system, or other networked computing infrastructure configured to provide services to the companion software application 122. In embodiments, the backend server 130 may be optional, and the combined heartbeat and melody system 100 may be configured to operate without the backend server 130. In embodiments, when present, the backend server 130 may be configured to store user data, store heartbeat patterns, store combined heartbeat patterns, store melodies, manage user accounts, and synchronize data across multiple user devices and multiple heartbeat simulation devices.

In embodiments, the backend server 130 may be configured to perform advanced processing. For example, in embodiments, the backend server 130 may be configured to execute AI-based combination processing to generate a combined heartbeat pattern from multiple inputs. In embodiments, the backend server 130 may be configured to execute AI-based melody generation to generate a harmonically constrained melody based on a heartbeat pattern. In embodiments, the backend server 130 may be configured to return outputs to the user device 120 for playback, export, or synchronization with the heartbeat simulation device 110. It is noted that in some embodiments, the AI-based combination processing may be performed at the user device 120.

In embodiments, the backend server 130 may be configured to support redundancy and recovery. For example, in embodiments, the backend server 130 may be configured to back up heartbeat patterns and melodies so that a user may restore such data if the user device 120 is replaced or lost. In embodiments, the backend server 130 may be configured to facilitate sharing or transfer of heartbeat patterns between authorized devices.

It is noted that, in embodiments, the functionality described above with respect to the backend server 130 may be implemented in user device 120. Similarly, the functionality described above with respect to the user device 120 may be implemented in the backend server 130.

In embodiments, the wireless communication link 140 may be configured to enable operational control of the heartbeat simulation device 110 by the companion software application 122. For example, in embodiments, the companion software application 122 may transmit commands to the heartbeat simulation device 110 to cause the heartbeat simulation device 110 to play a selected heartbeat pattern using tactile output, to play a selected melody using audio output, to switch from tactile mode to audio mode, and/or to adjust playback parameters. In embodiments, the heartbeat simulation device 110 may transmit information back to the companion software application 122, such as battery status, connectivity status, storage status, error conditions, current mode selection, and/or other device state information.

In embodiments, the network communication link 142 may be configured to allow the companion software application 122 to exchange data with the backend server 130. In embodiments, the companion software application 122 may upload heartbeat patterns and melody files to the backend server 130 for storage. In embodiments, the companion software application 122 may download heartbeat patterns and melody files from the backend server 130 to restore data or to synchronize across devices. In embodiments, the companion software application 122 may send a processing request to the backend server 130 and receive a processing response, such as a generated combined heartbeat pattern or a generated melody, which may then be stored locally, exported, and/or transmitted to the heartbeat simulation device 110.

In embodiments, the combined heartbeat and melody system 100 may be configured to operate under multiple processing distribution models. In embodiments, a first model may be a local model in which all processing occurs on the heartbeat simulation device 110 and the user device 120 without the backend server 130. In embodiments, a second model may be a cloud-assisted model in which the backend server 130 performs one or more processing operations. In embodiments, a third model may be a hybrid model in which some processing is performed locally and some processing is performed remotely, such as performing a preliminary combination operation locally and refining the combined heartbeat pattern remotely.

In embodiments, the combined heartbeat and melody system 100 may be configured to support a user-directed workflow. In such embodiments, the companion software application 122 may present a library of heartbeat patterns to a user. The user may select two heartbeat patterns and request generation of a combined heartbeat pattern. The companion software application 122 may generate the combined heartbeat pattern locally, may request the backend server 130 to generate the combined heartbeat pattern, or may instruct the heartbeat simulation device 110 to generate the combined heartbeat pattern locally. The resulting combined heartbeat pattern may be stored in the memory of the heartbeat simulation device 110 and may be played as tactile output, audio output, or both.

In embodiments, the combined heartbeat and melody system 100 may be configured to support an automatic interaction workflow. For example, in embodiments, two heartbeat simulation devices 110 may be brought into proximity and may detect each other. In embodiments, such detection may cause one or both heartbeat simulation devices 110 to initiate a combination process. In embodiments, the combination process may result in a combined heartbeat pattern that is played by one or both heartbeat simulation devices 110. In embodiments, the combined heartbeat pattern may be transient and only played during proximity, and in embodiments the combined heartbeat pattern may be stored for later use.

In embodiments, the combined heartbeat and melody system 100 may be configured to support a heartbeat-to-melody conversion workflow. In such embodiments, a heartbeat pattern, whether individual or combined, may be selected in the companion software application 122. The companion software application 122 may generate a melody from the heartbeat pattern locally or via the backend server 130. The generated melody may then be transmitted to the heartbeat simulation device 110 for playback through an audio output component, may be played on the user device 120, may be exported as a file, or may be stored for later playback.

In embodiments, the arrangement illustrated in FIG. 1 is exemplary and not limiting. In embodiments, the combined heartbeat and melody system 100 may omit the backend server 130. In embodiments, the combined heartbeat and melody system 100 may include additional devices, such as additional heartbeat simulation devices, additional user devices, and/or additional storage components. In embodiments, the communication links shown may be implemented using any suitable protocols. In embodiments, the functions described as performed by one component may be performed by another component, and multiple components may redundantly perform the same function, such that the disclosure is not limited to a single implementation.

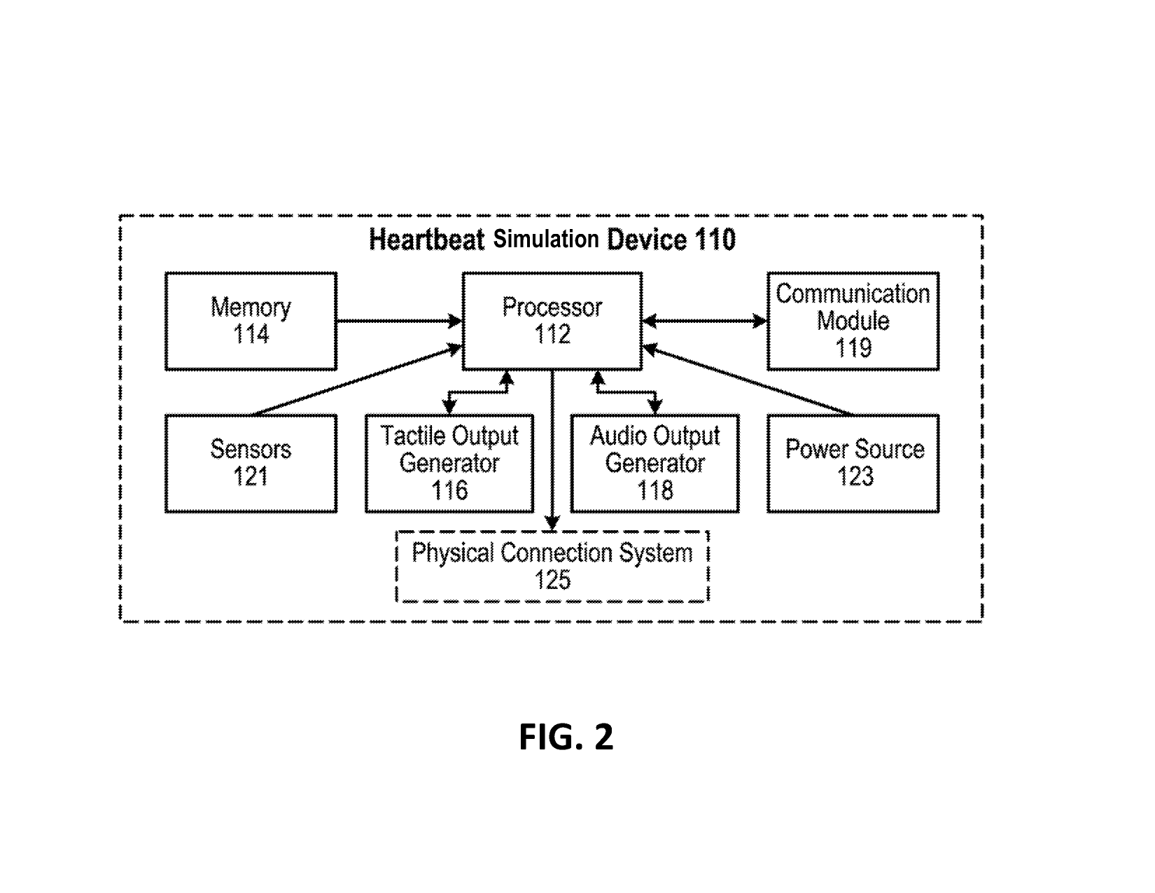

FIG. 2 is a diagram of a heartbeat simulation device 110 configured with functionality for combined operations in accordance with embodiments of the present disclosure. In embodiments, the heartbeat simulation device 110 may be a wearable electronic device configured to store, generate, combine, transform, and/or output heartbeat patterns and heartbeat-derived melodies. In embodiments, the heartbeat simulation device 110 may be configured to operate as a standalone device. In embodiments, the heartbeat simulation device 110 may be configured to operate in coordination with the user device 120, the companion software application 122, another heartbeat simulation device 110, or combinations thereof. The architecture illustrated in FIG. 2 is intended to be representative and non-limiting, and components may be added, removed, merged, or subdivided without departing from the scope of the disclosure.

In embodiments, the heartbeat simulation device 110 may include a housing configured to enclose and support the internal components illustrated in FIG. 2. In embodiments, the housing may be configured as a pendant, charm, locket, keychain, and/or other wearable form factor suitable for suspension from a chain, cord, band, and/or other wearable support. In embodiments, the housing may be formed from metal, polymer, ceramic, composite materials, and/or combinations thereof. In embodiments, the housing may be configured to protect internal components from environmental exposure, mechanical shock, routine handling, etc.

In embodiments, the heartbeat simulation device 110 may be configured to include all components for performing heartbeat playback and melody playback without continuous external connectivity. In embodiments, the heartbeat simulation device 110 may be configured to rely on external components for certain functions, such as advanced processing, storage expansion, and/or configuration, while still retaining core functionality locally. In embodiments, the heartbeat simulation device 110 may be configured to dynamically adjust its behavior based on available connectivity, power state, user-selected modes, etc.

In embodiments, the heartbeat simulation device 110 may include a processor 112. In embodiments, the processor 112 may be a microcontroller, microprocessor, system-on-chip, or other processing device configured to execute instructions and perform data processing operations. In embodiments, the processor 112 may be configured to execute firmware or software instructions stored in memory 114. In embodiments, the processor 112 may be configured to control operation of other components of the heartbeat simulation device 110, including output generators, sensors, and communication components.

Processor 112 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some embodiments, implementations of processor 112 may comprise code segments (e.g., software, firmware, and/or hardware logic) executable in hardware, such as a processor, to perform the tasks and functions described herein. In yet other embodiments, processor 112 may be implemented as a combination of hardware and software. Processor 112 may be communicatively coupled to memory 114.

In embodiments, the heartbeat simulation device 110 may include memory 114. In embodiments, the memory 114 may include one or more types of memory, including volatile memory, non-volatile memory, flash memory, or combinations thereof. In embodiments, the memory 114 may be configured to store executable instructions, configuration data, heartbeat pattern data, combined heartbeat pattern data, melody data, user preferences, and device state information. The memory 114 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. The memory 114 may comprise a processor readable medium configured to store one or more instruction sets (e.g., software, firmware, etc.) which, when executed by a processor (e.g., one or more processors of processor 112), perform tasks and functions as described herein.

Memory 114 may also be configured to facilitate storage operations. For example, the memory 114 may be configured to store a plurality of heartbeat patterns, including individual heartbeat patterns associated with one or more persons. In embodiments, the memory 114 may be configured to store one or more combined heartbeat patterns generated from two or more individual heartbeat patterns. In embodiments, the memory 114 may be configured to store metadata associated with heartbeat patterns, such as identifiers, timestamps, mode information, and relationship indicators. In embodiments, the processor 112 may be configured to retrieve heartbeat pattern data from the memory 114 and to process such data for playback or transformation.

In embodiments, the heartbeat simulation device 110 may include a tactile output generator 116. In embodiments, the tactile output generator 116 may be configured to physically reproduce a heartbeat pattern in a manner perceptible to a wearer of the heartbeat simulation device 110. In embodiments, the tactile output generator 116 may include one or more vibration motors, linear resonant actuators, eccentric rotating mass motors, solenoids, hammers, piezoelectric actuators, and/or other electromechanical components configured to generate a tactile sensation.

In embodiments, the tactile output generator 116 may be configured to reproduce timing characteristics of a heartbeat pattern, including beat intervals, pauses, and/or rhythm. In embodiments, the tactile output generator 116 may be configured to reproduce intensity characteristics of a heartbeat pattern, such as relative strength of beats or variations in amplitude. In embodiments, the tactile output generator 116 may be configured to reproduce complex heartbeat waveforms, including combined heartbeat patterns that incorporate features of multiple individual heartbeats.

In embodiments, the processor 112 may be configured to control the tactile output generator 116 by issuing control signals that correspond to heartbeat pattern data stored in memory 114. In embodiments, the processor 112 may be configured to adjust tactile playback parameters, such as intensity scaling, duration, repetition, and/or playback mode. In embodiments, the tactile output generator 116 may be configured to operate continuously, intermittently, and/or in response to events such as proximity detection, attachment, user input, scheduled playback, etc.

In embodiments, the heartbeat simulation device 110 may include an audio output generator 118. In embodiments, the audio output generator 118 may include a micro-speaker, piezoelectric transducer, bone-conduction transducer, and/or other audio-producing component. In embodiments, the audio output generator 118 may be configured to play a melody generated from a heartbeat pattern in accordance with embodiments of the present disclosure. In embodiments, the audio output generator 118 may be configured to output sound directly from the heartbeat simulation device 110.

In embodiments, the processor 112 may be configured to generate audio signals corresponding to a melody and to drive the audio output generator 118 accordingly. In embodiments, the processor 112 may be configured to retrieve melody data from memory 114 and to play such melody data through the audio output generator 118. In embodiments, the audio output generator 118 may be configured to operate in coordination with the tactile output generator 116, such that tactile heartbeat playback and audible melody playback may occur sequentially, concurrently, or independently.

In embodiments, the heartbeat simulation device 110 may be configured to switch between tactile output mode and audio output mode based on user input, gesture input, proximity events, attachment events, and/or commands received from the companion software application 122. In embodiments, the audio output generator 118 may be configured to adjust volume, tempo, or other playback parameters in response to configuration data.

In embodiments, the heartbeat simulation device 110 may include a communication module 119. The communication module 119 may be configured to communicate wirelessly with the user device 120 via the wireless communication link 140, or via a wired connection in some embodiments. In embodiments, the communication module 119 may include a Bluetooth or Bluetooth Low Energy transceiver. In embodiments, the communication module 119 may include additional wireless interfaces, such as Wi-Fi, near-field communication, or proprietary short-range communication protocols.

In embodiments, the communication module 119 may be configured to transmit heartbeat pattern data, combined heartbeat pattern data, melody data, device status information, and sensor data to the user device 120. In embodiments, the communication module 119 may be configured to receive configuration commands, mode selection commands, heartbeat pattern data, and melody data from the companion software application 122 executing on the user device 120.

In embodiments, the communication module 119 may further be configured to communicate directly with another heartbeat simulation device 110. In embodiments, such communication may be used to support proximity detection, device pairing, data exchange, and coordinated playback. In embodiments, direct device-to-device communication may occur without involving the user device 120 or the backend server 130.

In embodiments, the heartbeat simulation device 110 may include one or more sensors 121. In embodiments, the sensors 121 may include a proximity sensor configured to detect the presence of another heartbeat simulation device 110 within a predefined range. In embodiments, the sensors 121 may include a connection sensor configured to detect physical attachment between two heartbeat simulation devices 110 via the physical connection system 125.

In embodiments, the sensors 121 may include additional sensors, such as motion sensors, accelerometers, gyroscopes, touch sensors, capacitive sensors, or environmental sensors. In embodiments, such sensors may be configured to detect gestures, taps, orientation changes, touching, grasping, squeezing, pressing, and/or other user interactions. For example, the sensors 121 may include sensors to detect a user interaction with the heartbeat simulation device 110, such as the user wrapping their hand around the heartbeat simulation device 110, squeezing the heartbeat simulation device 110, and/or pressing the heartbeat simulation device 110 against the user’s body (e.g., their chest). In these embodiments, the heartbeat simulation device 110 may activate or trigger and may reproduce a heartbeat pattern in response to detecting the interaction by the user. In embodiments, sensor output may be provided to the processor 112, which may interpret such sensor data to trigger mode changes, playback initiation, or other actions.

In embodiments, the processor 112 may be configured to continuously or intermittently monitor sensor data. In embodiments, the processor 112 may be configured to apply thresholds, filters, and/or timing criteria to sensor data to reduce false triggers and improve reliability of detected events.

In embodiments, the heartbeat simulation device 110 may include a power source 123. In embodiments, the power source 123 may include a rechargeable battery, such as a lithium-ion or lithium-polymer battery. In embodiments, the power source 123 may be configured to supply electrical power to the processor 112, memory 114, tactile output generator 116, audio output generator 118, communication module 119, and sensors 121, and/or other components of the heartbeat simulation device 110.

In embodiments, the heartbeat simulation device 110 may be configured to manage power consumption based on operating mode, connectivity state, and battery level. In embodiments, the processor 112 may be configured to enter low-power or sleep states when the heartbeat simulation device 110 is idle, and to enter a normal-power mode in response to a detected user interaction. In embodiments, the heartbeat simulation device 110 may be configured to reduce output intensity, disable certain functions, and/or alter behavior when the battery level falls below a threshold.

In embodiments, the power source 123 may be rechargeable via an external charging interface. In embodiments, the power source 123 may be rechargeable via electrical contacts integrated into the physical connection system 125, such that two attached heartbeat simulation devices 110 may be charged simultaneously. In embodiments, the heartbeat simulation device 110 may be configured to report battery status to the companion software application 122.

In embodiments, the heartbeat simulation device 110 may include a physical connection system 125. In embodiments, the physical connection system 125 may be configured to physically attach the heartbeat simulation device 110 to another heartbeat simulation device 110. In embodiments, the physical connection system 125 may include magnets, mechanical interlocks, latches, snap-fit components, and/or combinations thereof. In embodiments, the physical connection system 125 may be configured to provide a secure but detachable connection.

In embodiments, the physical connection system 125 may include electrical contacts configured to enable power sharing, data sharing, or both between attached heartbeat simulation devices 110. In embodiments, such electrical contacts may be configured to allow direct data transfer between memories 114 of attached devices, or to allow one power source 123 to supply power to both devices.

In embodiments, the physical connection system 125 may be configured to provide a signal to the sensors 121 or the processor 112 indicating that attachment has occurred. In embodiments, detection of attachment may trigger a mode transition, generation of a combined heartbeat pattern, playback of a combined heartbeat pattern, storage of a combined heartbeat pattern, and/or other operations as described in subsequent sections.

In embodiments, the components of the heartbeat simulation device 110 may cooperate to achieve the overall functionality described herein. For example, in embodiments, the processor 112 may retrieve a heartbeat pattern from memory 114, generate control signals for the tactile output generator 116 to reproduce the heartbeat pattern, and simultaneously manage communication with the companion software application 122 to report playback status, in some embodiments in response to detecting a user interaction. In embodiments, the processor 112 may retrieve a melody from memory 114 and drive the audio output generator 118 to play the melody while monitoring sensor input to detect user interactions.

In embodiments, the processor 112 may coordinate data received via the communication module 119 with locally stored data in memory 114 to update heartbeat patterns, generate combined heartbeat patterns, and/or store new melody data. In embodiments, the processor 112 may respond to sensor input indicating proximity or attachment by initiating communication with another heartbeat simulation device 110 and executing logic associated with operational modes described in subsequent sections.

The architecture of the heartbeat simulation device 110 described herein provides a flexible, self-contained, and extensible platform that supports the wide range of interaction modes, processing pathways, and output modalities described throughout this disclosure.

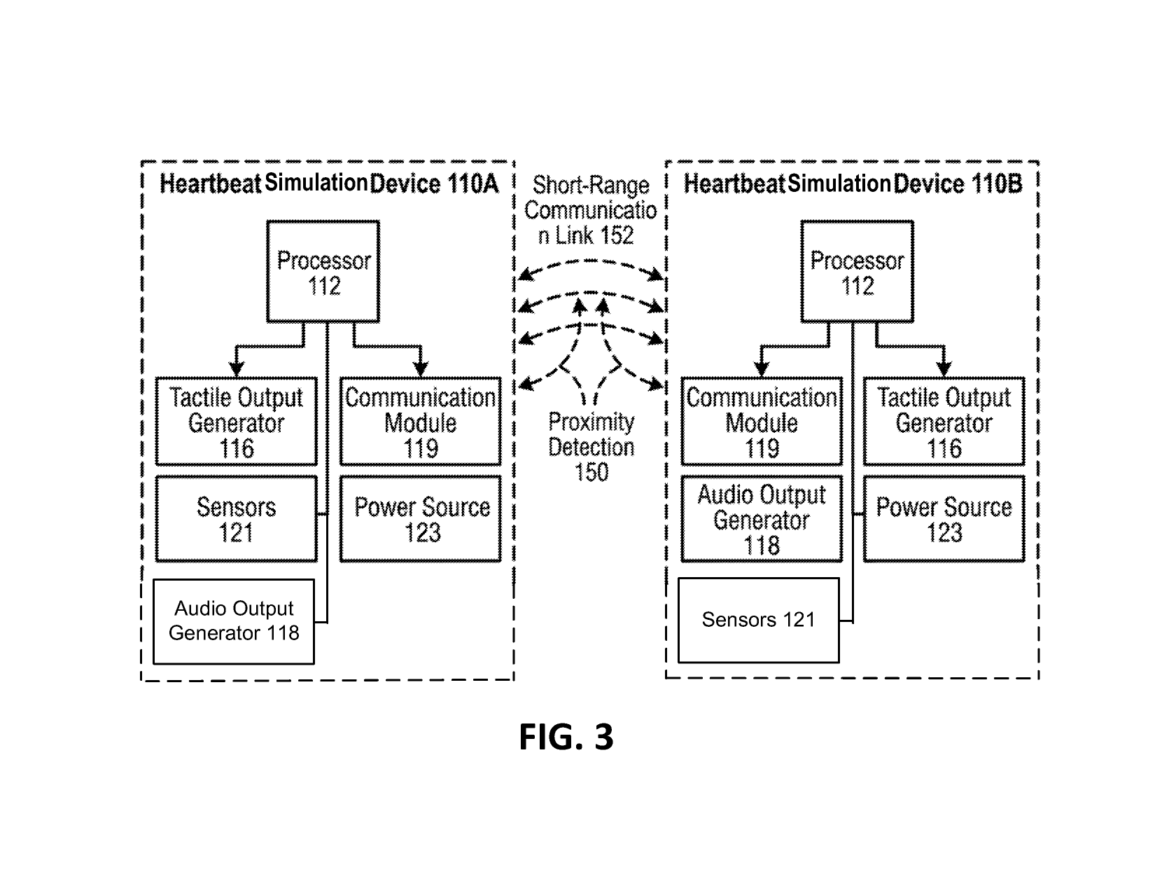

FIG. 3 is a diagram illustrating functionality for implementing combined operations of one or more heartbeat simulation devices 110 in accordance with embodiments of the present disclosure. As shown in the example illustrated in FIG. 3, two heartbeat simulation devices 110A and 110B may be positioned in proximity to one another without being physically attached. In embodiments, the proximity-based interaction illustrated in FIG. 3 may enable automatic, semi-automatic, and/or event-driven functionality between two heartbeat simulation devices 110 without requiring physical connection, direct user input, and/or intervention by the companion software application 122 at the time of interaction.

In embodiments, proximity-based interaction refers to functionality that is initiated, modified, and/or controlled when one heartbeat simulation device 110 detects the presence of another heartbeat simulation device 110 within a predefined spatial range. In embodiments, such proximity-based interaction may occur when the devices are within a distance of a few centimeters, a few inches, and/or a larger configurable range. In embodiments, the predefined range may be configurable by a user via the companion software application 122, or may be fixed by firmware or hardware design.

In embodiments, proximity-based interaction may be used to initiate heartbeat pattern combination, initiate playback of a combined heartbeat pattern, initiate melody playback, exchange data between devices, and/or signal a change in operational mode. In embodiments, proximity-based interaction may be distinct from physical attachment-based interaction in that the devices remain physically separate and are not mechanically or electrically coupled.

In embodiments, proximity detection 150 may be performed using one or more sensing or communication techniques implemented by the sensors 121 and the communication module 119 of each heartbeat simulation device 110. In embodiments, proximity detection 150 may be based on short-range wireless communication, such as Bluetooth Low Energy signal strength measurements, near-field communication detection, radio frequency identification techniques, and/or proprietary short-range radio protocols.

In embodiments, proximity detection 150 may be based on active communication, where one heartbeat simulation device 110 periodically broadcasts an identifier or beacon signal and another heartbeat simulation device 110 listens for such signal. In embodiments, proximity detection 150 may be based on passive detection, where a device responds only when interrogated by another device. In embodiments, proximity detection 150 may be based on bidirectional communication between heartbeat simulation devices 110A and 110B.

In embodiments, the short-range communication link 152 illustrated in FIG. 3 may be used both for proximity detection and for data exchange once proximity is detected. In embodiments, the short-range communication link 152 may be established directly between heartbeat simulation devices 110A and 110B without involvement of the user device 120 or the backend server 130.

In embodiments, detection of proximity between heartbeat simulation devices 110A and 110B may trigger one or more predefined actions. In embodiments, such actions may include initiating generation of a combined heartbeat pattern, initiating playback of a previously generated combined heartbeat pattern, initiating synchronization of stored heartbeat patterns, or initiating an exchange of configuration data.

In embodiments, proximity-triggered functionality may be automatic. For example, in embodiments, when heartbeat simulation device 110A detects heartbeat simulation device 110B within the predefined range, the processor 112 of heartbeat simulation device 110A may automatically initiate a combination process using heartbeat patterns stored locally in memory 114. In embodiments, heartbeat simulation device 110B may simultaneously or subsequently initiate a corresponding process.

In embodiments, proximity-triggered functionality may be conditional. For example, in embodiments, proximity detection may be required but not sufficient to initiate functionality, and additional criteria may be evaluated by the processor 112. Such criteria may include time thresholds, user-defined permissions, operational mode settings, battery level thresholds, and/or confirmation signals exchanged between devices.

In embodiments, once proximity is detected, the heartbeat simulation devices 110A and 110B may exchange data over the short-range communication link 152. In embodiments, such data exchange may include heartbeat pattern identifiers, heartbeat pattern data, timestamps, device identifiers, mode information, and/or other metadata.

In embodiments, data exchange may be used to determine which heartbeat patterns should be combined. For example, in embodiments, heartbeat simulation device 110A may transmit a reference to an individual heartbeat pattern stored in memory 114 of heartbeat simulation device 110A, while heartbeat simulation device 110B may transmit a reference to an individual heartbeat pattern stored in memory 114 of heartbeat simulation device 110B. In embodiments, one device may act as a primary device and perform the combination, while the other device may receive the resulting combined heartbeat pattern.

In embodiments, data exchange may be used to coordinate playback behavior. For example, in embodiments, heartbeat simulation device 110A and heartbeat simulation device 110B may synchronize playback of a combined heartbeat pattern such that tactile output or audio output occurs simultaneously, concurrently, individually, and/or in a coordinated manner.

In embodiments, proximity-based interaction may produce temporary effects. For example, in embodiments, a combined heartbeat pattern may be generated and played only while the devices remain within proximity, and may cease once the devices move outside the predefined range. In embodiments, such temporary behavior may be used to symbolize closeness without permanently altering stored data.

In embodiments, proximity-based interaction may produce persistent effects. For example, in embodiments, detection of proximity may trigger generation of a combined heartbeat pattern that is stored in memory 114 of one or both heartbeat simulation devices 110 for later use. In embodiments, such persistent storage may be subject to user confirmation, mode selection, and/or additional conditions.

In embodiments, the distinction between temporary and persistent proximity-based behavior may be configurable via the companion software application 122. In embodiments, a user may select whether proximity interaction results in transient playback only or results in permanent storage of a combined heartbeat pattern.

In embodiments, proximity-based interaction may operate independently of physical attachment-based interaction. In embodiments, proximity-based interaction may be used as a precursor to physical attachment-based interaction, such as triggering a preliminary combined heartbeat playback before attachment. In embodiments, proximity-based interaction may coexist with attachment-based interaction, and the system may select behavior based on whether attachment is detected.

In embodiments, proximity-based interaction may also operate independently of user-initiated interaction via the companion software application 122. In embodiments, proximity-based interaction may occur even when the companion software application 122 is not actively running or when the user device 120 is not nearby.

In embodiments, the proximity-based interaction illustrated in FIG. 3 is exemplary and non-limiting. In embodiments, proximity detection may be implemented using different sensing technologies, communication protocols, and/or distance thresholds. In embodiments, proximity-based interaction may be disabled, enabled, and/or modified via user settings. In embodiments, the functions triggered by proximity may vary depending on system configuration, device capabilities, and user preferences.

The proximity-based interaction described herein provides a foundation for intuitive, automatic, and emotionally resonant interactions between heartbeat simulation devices, while maintaining flexibility in how such interactions are initiated, processed, and resolved within the combined heartbeat and melody system 100.

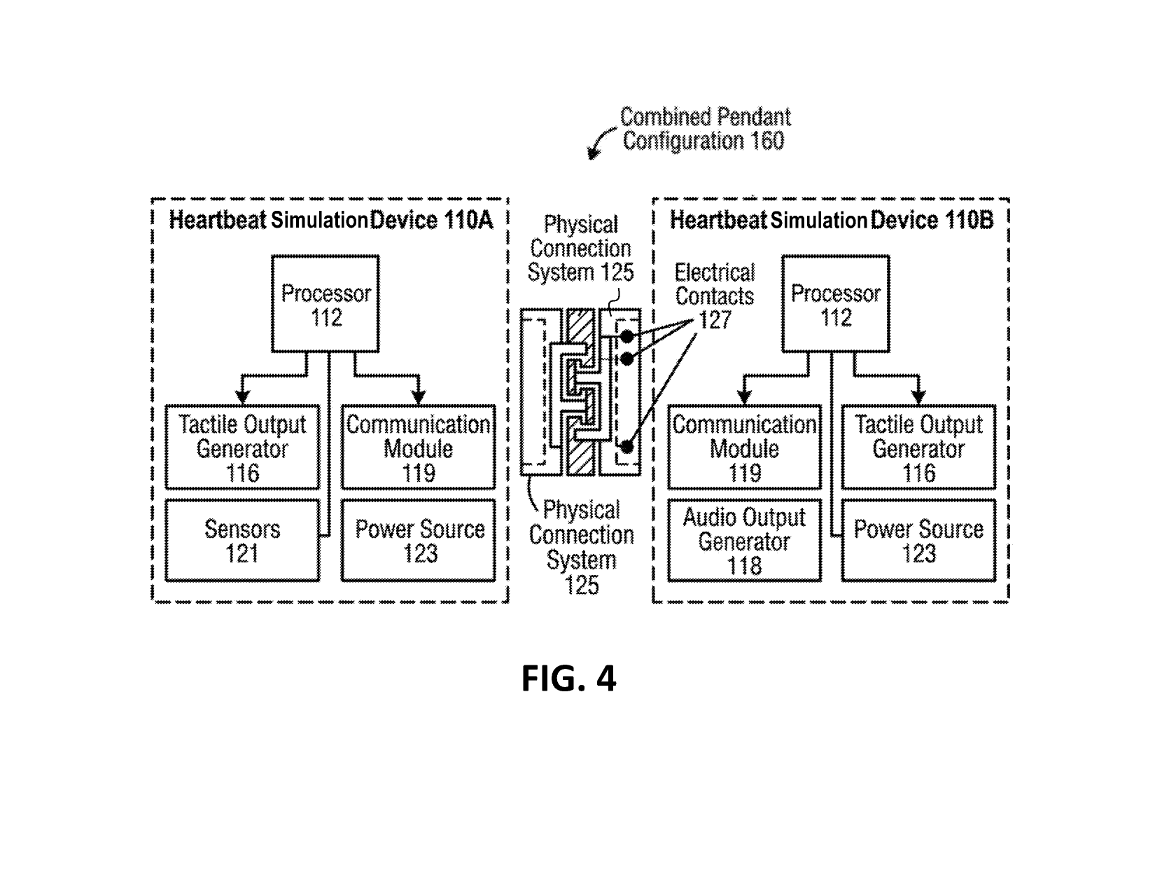

FIG. 4 is a diagram illustrating functionality for implementing combined operations of one or more physically attached heartbeat simulation devices 110 in accordance with embodiments of the present disclosure. As shown in FIG. 4, two heartbeat simulation devices 110A and 110B may be physically attached to one another to form a combined pendant configuration 160. In embodiments, the physically attached dual-pendant configuration provides both a symbolic and a functional coupling between the heartbeat simulation devices 110, enabling behaviors that are distinct from proximity-based interaction alone and that may involve mechanical coupling, electrical coupling, data coupling, and/or combinations thereof.

In embodiments, physical attachment may include a condition in which two heartbeat simulation devices 110 are mechanically joined such that relative movement between the devices is constrained. In embodiments, physical attachment may be achieved through the physical connection system 125 incorporated into each heartbeat simulation device 110. In embodiments, the physical connection system 125 may be configured to allow repeated attachment and detachment without damage to the devices.

In embodiments, physical attachment may be used as a deliberate user action indicating an intent to invoke a particular interaction mode. In some optional embodiments, physical attachment may serve as a stronger or more explicit signal than proximity alone, and may be associated with different system behavior, different persistence rules, and/or different processing logic.

In embodiments, the physical connection system 125 may include one or more magnets, mechanical interlocks, latching features, snap-fit components, mating geometries, or combinations thereof. In embodiments, the physical connection system 125 may be configured to guide the two heartbeat simulation devices 110 into a predetermined alignment when attached. In embodiments, such alignment may be configured to ensure proper orientation of internal components, electrical contacts, and/or sensor elements.

In embodiments, the physical connection system 125 may be configured to provide tactile feedback to a user when attachment occurs, such as a click, snap, and/or magnetic engagement sensation. In embodiments, the physical connection system 125 may be configured to resist accidental detachment while still permitting intentional detachment with reasonable force.

In embodiments, the physical connection system 125 may be configured as part of the external housing of the heartbeat simulation devices 110. In embodiments, the physical connection system 125 may be visually or geometrically complementary between devices 110A and 110B, such that the devices form a unified shape when attached.

In embodiments, when heartbeat simulation devices 110A and 110B are attached via the physical connection system 125, the devices may form a combined pendant configuration 160. In some embodiments, the combined pendant configuration 160 may be perceived by a user as a single pendant rather than two separate devices. In embodiments, the combined pendant configuration 160 may be symbolic, representing the joining of two individuals or two heartbeat patterns.

In embodiments, the combined pendant configuration 160 may also have functional implications. For example, in embodiments, the combined pendant configuration 160 may be associated with specific operational modes, such as a combined heartbeat playback mode or a synchronized combined mode. In embodiments, formation of the combined pendant configuration 160 may automatically trigger internal logic executed by the processor 112 of one or both heartbeat simulation devices 110.

In embodiments, detection of physical attachment may be performed using sensors 121 included in the heartbeat simulation devices 110. In embodiments, such sensors may include electrical contact sensors, magnetic field sensors, Hall-effect sensors, mechanical switches, capacitive sensors, or combinations thereof. In embodiments, detection of physical attachment may occur when the physical connection system 125 brings two devices into a specific spatial or electrical configuration.

In embodiments, detection of physical attachment may be communicated to the processor 112 of each heartbeat simulation device 110. In embodiments, the processor 112 may use such detection to determine that a physical attachment event has occurred, and may initiate corresponding logic. In some optional embodiments, the detection of physical attachment may be more definitive than proximity detection and may therefore be used to trigger actions that may not be triggered by proximity alone.

In embodiments, the physical connection system 125 may include electrical contacts 127. In embodiments, the electrical contacts 127 may be configured to establish an electrical connection between heartbeat simulation devices 110A and 110B when attached. In embodiments, such electrical connection may enable power sharing, data sharing, or both.

In embodiments, power sharing may include supplying power from the power source 123 of one heartbeat simulation device 110 to the other heartbeat simulation device 110. In embodiments, power sharing may be used to equalize battery levels, to extend operational time, and/or to allow both devices to be charged simultaneously through a single charging interface.

In embodiments, data sharing may include direct data transfer between memories 114 of the attached heartbeat simulation devices 110. In embodiments, data sharing may be used to exchange heartbeat pattern data, combined heartbeat pattern data, configuration data, mode selection data, and/or other information without requiring wireless communication. In embodiments, data sharing via electrical contacts 127 may be faster, more reliable, and/or more energy-efficient than wireless communication.

In embodiments, physical attachment of heartbeat simulation devices 110A and 110B may trigger generation of a combined heartbeat pattern. In embodiments, such combined heartbeat pattern may be generated immediately upon attachment. In embodiments, the combined heartbeat pattern may be generated locally by one device, cooperatively by both devices, and/or by one device acting as a primary processor.

In embodiments, physical attachment may trigger playback of a combined heartbeat pattern through the tactile output generator 116, the audio output generator 118, or both. In embodiments, playback may occur on one heartbeat simulation device 110 or on both heartbeat simulation devices 110 simultaneously (e.g., both heartbeat simulation devices 110a and 110b reproduce the combined heartbeat pattern concurrently) or in a coordinated manner (e.g., the heartbeat simulation device 110a reproduces a first portion of the combined heartbeat pattern and the heartbeat simulation device 110b reproduces a second portion of the combined heartbeat pattern, or the heartbeat simulation device 110a reproduces the first heartbeat pattern and the heartbeat simulation device 110b reproduces the second heartbeat pattern at particular levels such that the concurrent reproduction of the first heartbeat pattern and the second heartbeat pattern represent a reproduction or playback of the combined heartbeat pattern).

In embodiments, physical attachment may trigger storage of a combined heartbeat pattern in memory 114 of one or both heartbeat simulation devices 110. In embodiments, such storage may be permanent or temporary, depending on operational mode settings described in subsequent sections. In embodiments, physical attachment may also trigger synchronization of stored data between devices.

In some alternative or optional embodiments, physical attachment-based interaction may be distinct from proximity-based interaction in both detection mechanism and resulting behavior. For example, proximity detection may indicate closeness without physical commitment, whereas physical attachment may indicate a deliberate joining action by the user. In these embodiments, the combined heartbeat and melody system 100 may be configured such that certain actions occur only upon physical attachment and not upon proximity alone. For example, such actions may include persistent storage of combined heartbeat patterns, power sharing, direct data transfer, and/or transition into synchronized combined modes.

In embodiments, physical detachment of heartbeat simulation devices 110A and 110B may be detected by the sensors 121. In embodiments, detection of detachment may cause the processor 112 to initiate logic associated with separation. In embodiments, such logic may include reverting to individual heartbeat playback, maintaining playback of a combined heartbeat pattern, deleting or retaining stored combined heartbeat patterns, and/or transitioning to a different operational mode.

In embodiments, detachment behavior may be configurable via the companion software application 122. In embodiments, a user may select whether detachment causes immediate reversion to individual heartbeat patterns or whether a combined heartbeat pattern persists after detachment.

In embodiments, the physically attached dual-pendant configuration illustrated in FIG. 4 is exemplary and non-limiting. In embodiments, different physical connection mechanisms, different electrical coupling arrangements, or different attachment detection techniques may be used. In embodiments, the combined pendant configuration 160 may take different shapes, sizes, and/or symbolic forms. In embodiments, attachment-based behavior may vary based on user preferences, system configuration, or device capabilities.

The physically attached dual-pendant configuration described herein provides a robust foundation for deliberate, meaningful interaction between heartbeat simulation devices, enabling both mechanical and electronic cooperation to support the broader functionality of the combined heartbeat and melody system 100.

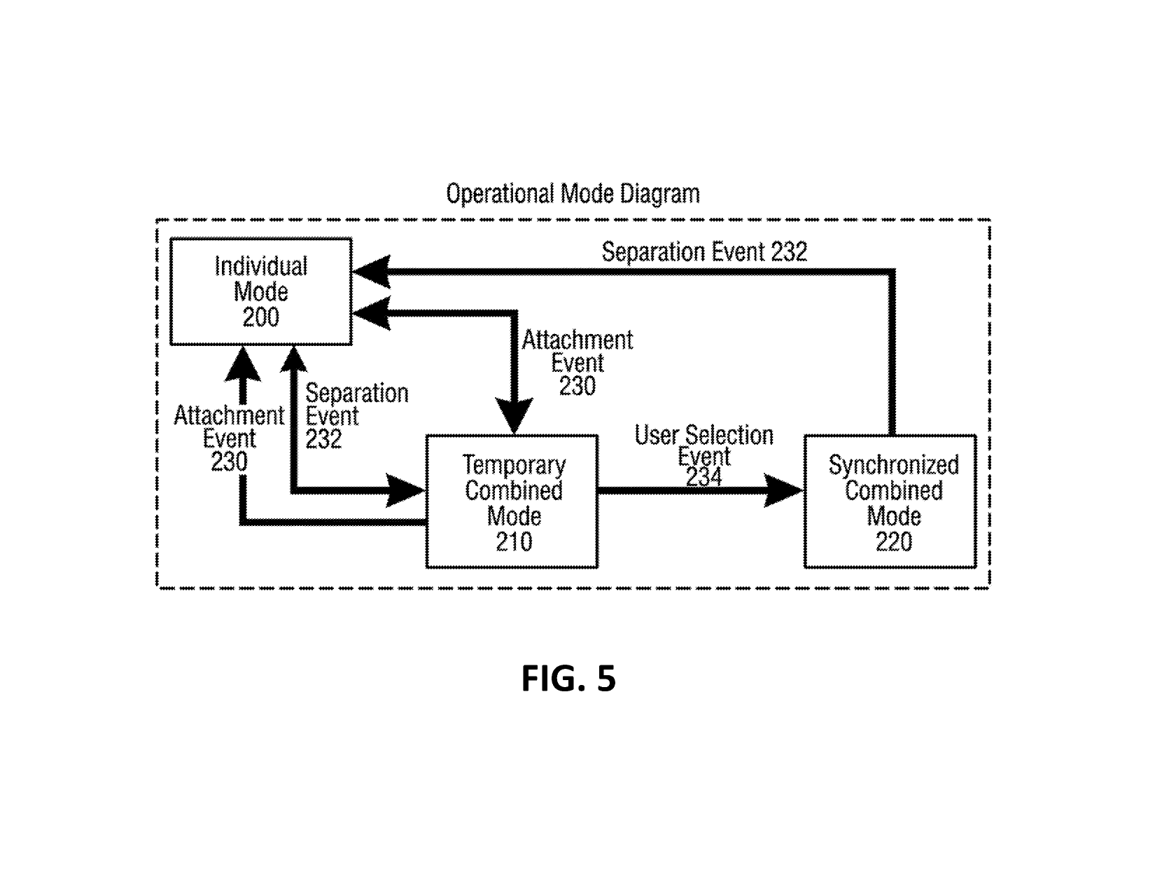

FIG. 5 is a block diagram illustrating an operational mode for the heartbeat simulation devices 110 in accordance with embodiments of the present disclosure. In embodiments, the heartbeat simulation device 110 may be configured to operate in a plurality of distinct operational modes, each defining how heartbeat patterns are selected, generated, stored, and/or output. In embodiments, the operational modes may be mutually exclusive at a given time. In embodiments, the operational modes may be selectively activated, transitioned, or overridden based on detected events, user input, configuration data, or combinations thereof.

In embodiments, the operational modes described herein provide a structured framework that governs device behavior in response to proximity events, attachment events, separation events, and/or user selection events. In embodiments, the operational modes may be implemented as logical states maintained by the processor 112 and stored or tracked using memory 114. In embodiments, transitions between operational modes may be triggered automatically or manually, as described herein.

In embodiments, the heartbeat simulation devices 110 may operate in an Individual Mode 200. In embodiments, Individual Mode 200 may be the default operational mode when a heartbeat simulation device 110 is not in proximity to another device or not physically attached to another device. In embodiments, in Individual Mode 200, the heartbeat simulation device 110 may be configured to output an individual heartbeat pattern associated with that device. For example, the heartbeat simulation device 110 may detect (e.g., using one or more sensors 121) a user interaction (such as the user wrapping their hand around the heartbeat simulation device 110, squeezing the heartbeat simulation device 110, and/or pressing the heartbeat simulation device 110 against the user’s body (e.g., their chest)), and the heartbeat simulation device 110 may output the individual heartbeat pattern in response to the detected user interaction. In some embodiments, output of the individual heartbeat pattern may cease when the user interaction is no longer detected.

In embodiments, the individual heartbeat pattern output in Individual Mode 200 may be stored in memory 114 of the heartbeat simulation device 110. The individual heartbeat pattern may correspond to a heartbeat captured from a specific person or pet, such as the wearer of the device or another person or pet. In embodiments, the individual heartbeat pattern may be output using the tactile output generator 116, the audio output generator 118, or both.

In embodiments, while operating in Individual Mode 200, the heartbeat simulation device 110 may still monitor sensor input from sensors 121. In embodiments, such monitoring may include monitoring for proximity detection, attachment detection, gesture detection, and/or further user interaction. In embodiments, detection of certain events while in Individual Mode 200 may trigger a transition to another operational mode, as described below.

In embodiments, the heartbeat simulation devices 110 may operate in a Temporary Combined Mode 210. In embodiments, Temporary Combined Mode 210 may be activated in response to a triggering event such as a proximity event or an attachment event. In embodiments, Temporary Combined Mode 210 may be configured such that a combined heartbeat pattern is generated and output only while the triggering condition persists (e.g., the combined heartbeat pattern may be output in response to detecting a user interaction (such as the user wrapping their hand around the heartbeat simulation device 110, squeezing the heartbeat simulation device 110, and/or pressing the heartbeat simulation device 110 against the user’s body (e.g., their chest), while the triggering condition persists). In some embodiments, output of the combined heartbeat pattern may cease when the user interaction is no longer detected.

In embodiments, in Temporary Combined Mode 210, the heartbeat simulation devices 110 may be configured to generate a combined heartbeat pattern from two or more individual heartbeat patterns. In embodiments, the combined heartbeat pattern may be generated locally by one heartbeat simulation device 110, cooperatively by two heartbeat simulation devices 110, or using processing resources provided by the user device 120 or the backend server 130.

In embodiments, the combined heartbeat pattern generated in Temporary Combined Mode 210 may not be permanently stored in memory 114. In embodiments, the combined heartbeat pattern may be discarded when the triggering condition ends, such as when devices move out of proximity or when devices are physically detached. In embodiments, Temporary Combined Mode 210 may provide a transient or ephemeral combined heartbeat experience.

In embodiments, Temporary Combined Mode 210 may be used to symbolize closeness or connection that exists only while devices are near or attached. In embodiments, playback in Temporary Combined Mode 210 may occur using tactile output, audio output, or both. In embodiments, upon termination of the triggering condition, the heartbeat simulation devices 110 may automatically revert to Individual Mode 200.

In embodiments, the heartbeat simulation devices 110 may operate in a Synchronized Combined Mode 220. In embodiments, Synchronized Combined Mode 220 may be activated in response to a triggering event, such as a physical attachment event, combined with a configuration setting or user selection. In embodiments, Synchronized Combined Mode 220 may be configured to create a persistent combined heartbeat pattern.

In embodiments, in Synchronized Combined Mode 220, a combined heartbeat pattern may be generated from two or more individual heartbeat patterns and may be stored in memory 114 of one or both heartbeat simulation devices 110. In embodiments, the stored combined heartbeat pattern may persist even after the triggering condition ends, such as after physical detachment of the devices.

In embodiments, while operating in Synchronized Combined Mode 220, each heartbeat simulation device 110 may be configured to output the same combined heartbeat pattern, even when separated. In embodiments, such synchronized output may symbolize a continued connection between the associated individuals despite physical separation. For example, in Synchronized Combined Mode 220, each heartbeat simulation device 110 may be configured to output the same combined heartbeat pattern in response to detecting a user interaction (and in some embodiments, output of the combined heartbeat pattern may cease when the user interaction is no longer detected).

In embodiments, while operating in Synchronized Combined Mode 220, each heartbeat simulation device 110 may be configured to output a different portion of the combined heartbeat pattern, at least while attached to each other (in response to a user interaction and while detecting the user interaction). In some embodiments, in the Synchronized Combined Mode 220, the heartbeat simulation devices 110 may be configured to output (at least while detecting a user interaction) each a corresponding heartbeat pattern (e.g., the individual heartbeat pattern associated with each of the devices) at particular levels such that the concurrent reproduction of the individual heartbeat patterns represents or is perceived as a reproduction or playback of the combined heartbeat pattern.

In embodiments, the combined heartbeat pattern stored in Synchronized Combined Mode 220 may replace the individual heartbeat pattern for playback purposes, or may be stored alongside individual heartbeat patterns. In embodiments, the combined heartbeat pattern may be designated as a primary pattern, a default pattern, and/or a selectable pattern.

In embodiments, transitions between operational modes may be governed by specific triggering events illustrated in FIG. 5. In embodiments, an Attachment Event 230 may be detected when two heartbeat simulation devices 110 are physically attached via the physical connection system 125. In embodiments, detection of an Attachment Event 230 may trigger a transition from Individual Mode 200 to Temporary Combined Mode 210 or to Synchronized Combined Mode 220, depending on configuration.

In embodiments, a Separation Event 232 may be detected when physically attached heartbeat simulation devices 110 are detached. In embodiments, detection of a Separation Event 232 may trigger a transition from Temporary Combined Mode 210 back to Individual Mode 200. In embodiments, in Synchronized Combined Mode 220, detection of a Separation Event 232 may not trigger reversion to Individual Mode 200, and the devices may remain configured to output the combined heartbeat pattern.

In embodiments, a User Selection Event 234 may be generated via the companion software application 122. In embodiments, the User Selection Event 234 may be used to explicitly select an operational mode, override automatic mode transitions, and/or revert stored patterns. In embodiments, user selection may allow a user to enable or disable Synchronized Combined Mode 220, to convert a temporary combined heartbeat pattern into a persistent combined heartbeat pattern, and/or to uncouple previously synchronized devices.

In embodiments, configuration of operational modes may be performed via the companion software application 122. In embodiments, the companion software application 122 may provide controls that allow a user to select default behaviors for proximity events, attachment events, and separation events. In embodiments, such controls may include enabling or disabling automatic mode transitions, selecting whether combined heartbeat patterns are stored, and/or selecting whether combined heartbeat patterns persist after separation.

In embodiments, operational mode configuration data may be transmitted from the companion software application 122 to the heartbeat simulation devices 110 via the wireless communication link 140. In embodiments, such configuration data may be stored in memory 114 and used by the processor 112 to govern behavior.

In embodiments, the processor 112 of each heartbeat simulation device 110 may maintain a current operational mode state. In embodiments, the processor 112 may evaluate sensor input, received commands, and stored configuration data to determine whether a mode transition should occur. In embodiments, the processor 112 may ensure that transitions between operational modes are performed in a controlled manner, such as completing playback of a heartbeat pattern before switching modes or synchronizing mode transitions between two devices.

In embodiments, the processor 112 may coordinate operational mode transitions with other components of the heartbeat simulation device 110. For example, in embodiments, transitioning into Temporary Combined Mode 210 or Synchronized Combined Mode 220 may cause the processor 112 to initiate generation of a combined heartbeat pattern, update memory 114, and configure the tactile output generator 116 or audio output generator 118 for playback of the combined pattern.

In embodiments, the operational modes illustrated in FIG. 5 are exemplary and non-limiting. In embodiments, additional operational modes may be defined. In embodiments, one or more operational modes may be omitted. In embodiments, transitions between modes may be modified or supplemented with additional conditions. In embodiments, the specific behaviors associated with each operational mode may vary based on implementation, user preferences, or device capabilities.

The operational modes described herein provide a flexible and expressive mechanism for governing how heartbeat simulation devices 110 behave in response to interaction events, enabling both transient and persistent expressions of connection within the combined heartbeat and melody system 100.

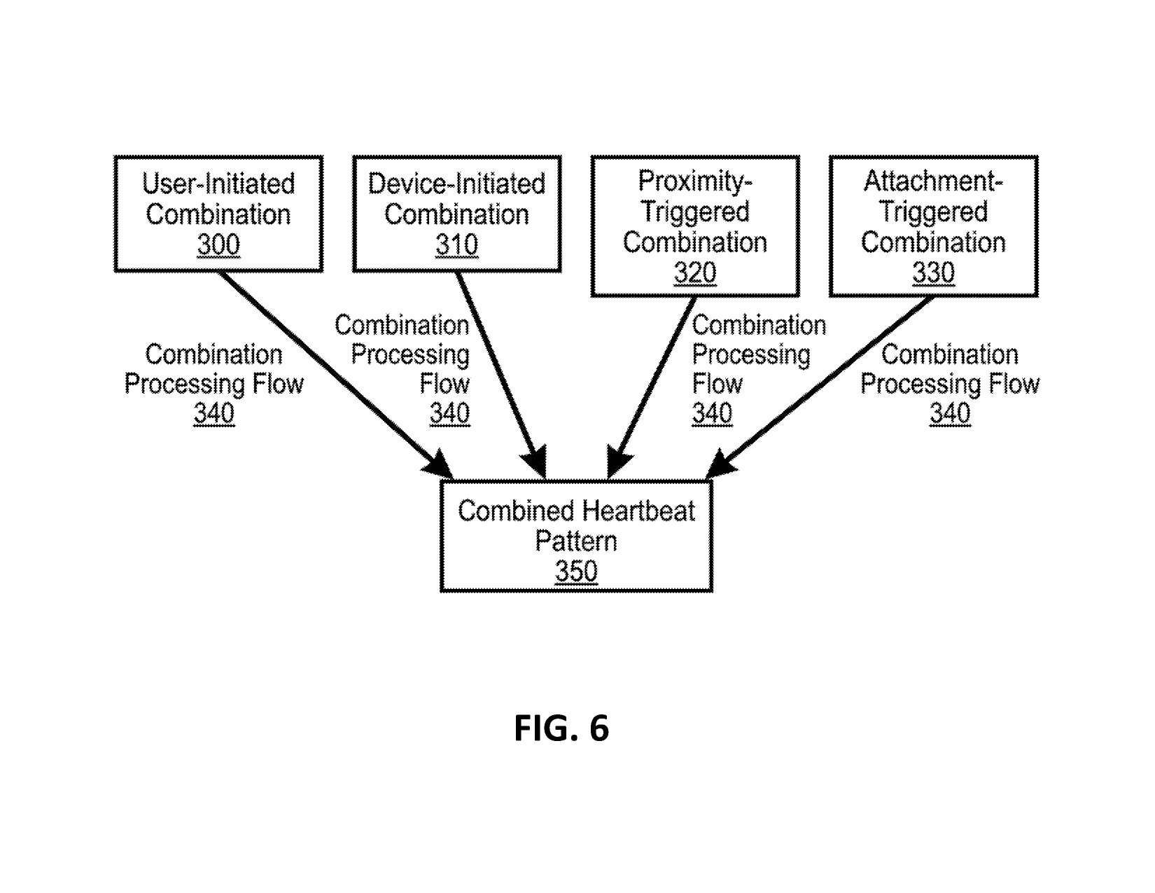

FIG. 6 is a flow diagram illustrating various embodiments for initiation and processing of heartbeat pattern combination within the combined heartbeat and melody system 100 in accordance with embodiments of the present disclosure. In embodiments, the generation of a combined heartbeat pattern may be initiated through multiple distinct pathways and may be processed at different locations within the system architecture. In embodiments, the flexibility of initiation and locus of processing allows the system 100 to adapt to differing device capabilities, connectivity conditions, user preferences, and/or operational modes without limiting the disclosure to a single processing model.

In embodiments, heartbeat pattern combination refers to the creation of a new heartbeat pattern derived from two or more source heartbeat patterns. In embodiments, the source heartbeat patterns may be individual heartbeat patterns associated with different persons or pets, or from the same person or pet. In embodiments, the combined heartbeat pattern may preserve characteristics of each source heartbeat pattern while forming a unified output pattern suitable for tactile playback, audio-derived melody generation, or both.

In embodiments, FIG. 6 illustrates multiple initiation pathways through which heartbeat pattern combination may occur. In embodiments, these initiation pathways may include user-initiated combination 300, device-initiated combination 310, proximity-triggered combination 320, and/or attachment-triggered combination 330. In embodiments, each initiation pathway may result in a combination processing flow 340 that produces a combined heartbeat pattern 350.

In embodiments, the initiation pathway may determine not only when combination occurs, but also where combination processing occurs and whether the resulting combined heartbeat pattern is temporary or persistent. In embodiments, initiation pathways may be mutually exclusive or may operate concurrently depending on configuration.

In embodiments, user-initiated combination 300 may occur when a user explicitly requests generation of a combined heartbeat pattern via the companion software application 122 executing on the user device 120. In embodiments, the companion software application 122 may present a user interface allowing selection of two or more heartbeat patterns from the heartbeat library. In embodiments, the user may initiate combination by selecting a combination command, button, gesture, and/or other input mechanism.

In embodiments, once user-initiated combination 300 occurs, the companion software application 122 may determine where combination processing is performed. In embodiments, the companion software application 122 may perform combination processing locally on the user device 120. In embodiments, the companion software application 122 may instruct the heartbeat simulation device 110 to perform combination processing locally. In embodiments, the companion software application 122 may transmit a request to the backend server 130 to perform combination processing remotely.

In embodiments, user-initiated combination 300 may be associated with a higher level of user intent and may result in persistent storage of the combined heartbeat pattern. In embodiments, the combined heartbeat pattern 350 generated via user-initiated combination 300 may be stored in memory 114 of one or more heartbeat simulation devices 110 and may also be stored in the heartbeat library maintained by the companion software application 122.

In embodiments, device-initiated combination 310 may occur when a heartbeat simulation device 110 autonomously initiates combination processing without direct user input at that moment. In embodiments, device-initiated combination 310 may be triggered by internal logic executed by the processor 112 in response to detected events, configuration settings, or stored rules.

In embodiments, device-initiated combination 310 may occur when two heartbeat simulation devices 110 have previously been paired or associated and certain conditions are met. For example, in embodiments, device-initiated combination 310 may occur when a device detects that it is operating in a specific operational mode, such as Temporary Combined Mode 210 or Synchronized Combined Mode 220.

In embodiments, device-initiated combination 310 may be performed entirely locally on one heartbeat simulation device 110. In embodiments, device-initiated combination 310 may involve coordination between two heartbeat simulation devices 110, such that one device performs the combination and transmits the resulting combined heartbeat pattern 350 to the other device.

In embodiments, proximity-triggered combination 320 may occur when two heartbeat simulation devices 110 detect one another within a predefined proximity range, as described previously with reference to FIG. 3. In embodiments, detection of proximity may serve as an implicit initiation signal indicating that combination processing should occur.

In embodiments, proximity-triggered combination 320 may result in temporary generation of a combined heartbeat pattern 350 that is played only while the devices remain within proximity. In embodiments, proximity-triggered combination 320 may result in persistent generation of a combined heartbeat pattern 350 if configuration settings allow or if additional confirmation conditions are met.

In embodiments, proximity-triggered combination 320 may be performed locally by one heartbeat simulation device 110, cooperatively by both heartbeat simulation devices 110, and/or by the user device 120 if present. In embodiments, proximity-triggered combination 320 may operate without requiring interaction with the companion software application 122 at the time of initiation.

In embodiments, attachment-triggered combination 330 may occur when two heartbeat simulation devices 110 are physically attached via the physical connection system 125, as described previously with reference to FIG. 4. In embodiments, detection of physical attachment may serve as a strong initiation signal indicating user intent to generate a combined heartbeat pattern.

In embodiments, attachment-triggered combination 330 may occur immediately upon detection of attachment. In embodiments, attachment-triggered combination 330 may occur after additional conditions are met, such as confirmation from the companion software application 122 or satisfaction of configuration rules.

In embodiments, attachment-triggered combination 330 may be associated with Synchronized Combined Mode 220, and may result in persistent storage of the combined heartbeat pattern 350 in memory 114 of both heartbeat simulation devices 110. In embodiments, attachment-triggered combination 330 may involve direct data exchange between devices via electrical contacts 127 or via short-range communication. In some embodiments, attachment-triggered combination 330 may result in temporary generation of a combined heartbeat pattern 350 that is played only while the devices remain attached and ceases once the devices are detached from one another.

In embodiments, regardless of initiation pathway, heartbeat pattern combination may proceed through a combination processing flow 340. In embodiments, the combination processing flow 340 may include retrieval of source heartbeat patterns, application of one or more combination algorithms, and generation (and/or output) of a combined heartbeat pattern 350.

In embodiments, the locus of processing for the combination processing flow 340 may vary. In embodiments, processing may occur on the heartbeat simulation device 110 using the processor 112. In embodiments, processing may occur on the user device 120 using processing resources available to the companion software application 122. In embodiments, processing may occur on the backend server 130 using remote processing resources.

In embodiments, the choice of processing locus may depend on factors such as computational complexity, battery state, connectivity availability, user preference, and/or system configuration. In embodiments, the companion software application 122 may dynamically select the processing locus based on such factors.

In embodiments, the result of the combination processing flow 340 may be a combined heartbeat pattern 350. In embodiments, the combined heartbeat pattern 350 may be represented as waveform data, timing data, intensity data, and/or other data structures suitable for playback, reproduction, and/or further transformation.

In embodiments, the combined heartbeat pattern 350 may be stored temporarily or persistently. In embodiments, the combined heartbeat pattern 350 may be stored in memory 114 of one or more heartbeat simulation devices 110. In embodiments, the combined heartbeat pattern 350 may be stored in the companion software application 122 and optionally synchronized to the backend server 130.

In embodiments, the combined heartbeat pattern 350 may be immediately played back, output or reproduced using the tactile output generator 116 and/or may be used as an input to melody generation as described in subsequent sections. In embodiments, the combined heartbeat pattern 350 may be tagged with metadata indicating its origin, initiation pathway, associated devices, and/or operational mode.

In embodiments, the initiation pathways and processing flows illustrated in FIG. 6 are exemplary and non-limiting. In embodiments, additional initiation pathways may be defined. In embodiments, one or more initiation pathways may be disabled or modified. In embodiments, the processing locus may be fixed or dynamically selected.

The initiation and locus flexibility described herein ensures that heartbeat pattern combination within the combined heartbeat and melody system 100 may be responsive, efficient, and adaptable across a wide range of use cases and operating conditions.

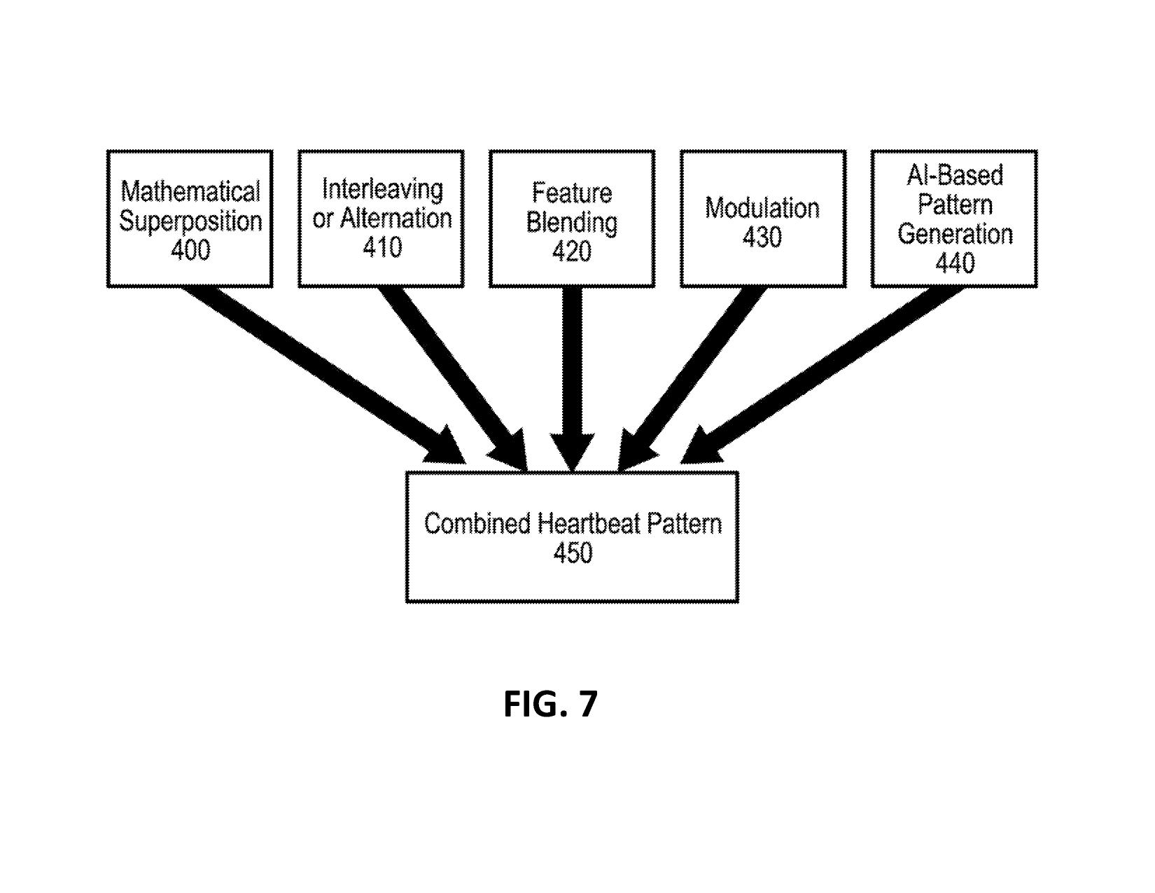

FIG. 7 is an algorithmic diagram illustrating multiple embodiments of heartbeat pattern combination techniques that may be employed by the combined heartbeat and melody system 100 in accordance with embodiments of the present disclosure. In embodiments, the heartbeat pattern combination techniques described herein may be used individually or in combination to generate a combined heartbeat pattern 450 from two or more source heartbeat patterns. The choice of combination technique may depend on user preferences, operational mode, processing locus, device capabilities, and/or configuration settings, and no single technique is intended to be limiting.

In embodiments, a heartbeat pattern may be represented digitally as a sequence of timing intervals, amplitude values, waveform samples, event markers corresponding to beats, or combinations thereof. In embodiments, combination techniques may operate on one or more of these representations. In embodiments, the combination techniques may be executed by the processor 112 of the heartbeat simulation device 110, by the user device 120 executing the companion software application 122, by the backend server 130, or by combinations thereof.

In embodiments, a heartbeat pattern combination technique may include mathematical superposition 400. In embodiments, mathematical superposition 400 may involve combining two or more heartbeat patterns by mathematically adding, averaging, or otherwise aggregating corresponding values of the source heartbeat patterns.

In embodiments, mathematical superposition 400 may operate on waveform data such that amplitude values of two heartbeat waveforms are added or averaged at corresponding time points to produce a new waveform. In embodiments, mathematical superposition 400 may operate on timing data such that beat intervals from multiple heartbeat patterns are combined to produce a composite timing sequence.

In embodiments, mathematical superposition 400 may preserve simultaneous characteristics of the source heartbeat patterns, such that overlapping beats, variations in intensity, or fluctuations in rhythm are reflected in the combined heartbeat pattern 450. In embodiments, mathematical superposition 400 may be computationally efficient and may be suitable for real-time generation on resource-constrained devices.

In embodiments, the processor 112 may be configured to normalize or scale the output of mathematical superposition 400 to ensure that the combined heartbeat pattern 450 remains within acceptable tactile or audio output ranges. In embodiments, normalization may prevent excessive intensity or unintended distortion during playback.

In embodiments, another heartbeat pattern combination technique may include interleaving or alternation 410. In embodiments, interleaving or alternation 410 may involve combining heartbeat patterns by alternating beats, beat groups, or time segments from each source heartbeat pattern.

In embodiments, interleaving or alternation 410 may be implemented on a beat-by-beat basis, where individual beats from one heartbeat pattern are alternated with individual beats from another heartbeat pattern. In embodiments, interleaving or alternation 410 may be implemented on a segment-by-segment basis, where short time segments of one heartbeat pattern are followed by short time segments of another heartbeat pattern.

In embodiments, interleaving or alternation 410 may preserve the identity of each source heartbeat pattern while creating a rhythmic dialogue between them. In embodiments, such a technique may be particularly suitable for tactile playback, where alternating pulses may be perceptible as distinct contributions from each source.

In embodiments, parameters governing interleaving or alternation 410, such as segment duration, beat grouping, or switching frequency, may be configurable via the companion software application 122 or via stored configuration data.

In embodiments, still another heartbeat pattern combination technique may include feature blending 420. In embodiments, feature blending 420 may involve extracting key characteristics from each source heartbeat pattern and generating a new heartbeat pattern based on blended or averaged features.

In embodiments, extracted features may include beats-per-minute, average beat interval, variability metrics, intensity levels, lub-dub timing relationships, waveform shape characteristics, and/or other descriptors of heartbeat behavior. In embodiments, feature blending 420 may compute averages, weighted averages, or other combinations of such features.

In embodiments, the combined heartbeat pattern 450 generated via feature blending 420 may not directly resemble either source heartbeat pattern in isolation, but may instead represent a synthesized pattern that reflects shared characteristics. In embodiments, feature blending 420 may produce a smooth and harmonious combined heartbeat pattern suitable for continuous playback. In embodiments, feature blending 420 may be advantageous when the source heartbeat patterns differ significantly, such as in tempo or intensity, and a balanced combined output is desired.

In embodiments, yet another heartbeat pattern combination technique may include modulation 430. In embodiments, modulation 430 may involve using one heartbeat pattern as a carrier signal and another heartbeat pattern as a modulating signal. In embodiments, characteristics of the modulating heartbeat pattern may be used to vary characteristics of the carrier heartbeat pattern.

In embodiments, modulation 430 may include amplitude modulation, where the intensity of the carrier heartbeat pattern is varied based on the modulating heartbeat pattern. In embodiments, modulation 430 may include frequency or timing modulation, where beat timing or spacing of the carrier heartbeat pattern is influenced by the modulating heartbeat pattern.

In embodiments, modulation 430 may produce a complex combined heartbeat pattern 450 in which one heartbeat pattern dynamically influences the expression of the other. In embodiments, such modulation-based techniques may result in rich tactile experiences or nuanced rhythmic structures.

In embodiments, modulation parameters may be configurable, allowing selection of which heartbeat pattern acts as the carrier and which acts as the modulator, as well as the strength or depth of modulation.

In embodiments, another heartbeat pattern combination technique may include AI-based pattern generation 440. In embodiments, AI-based pattern generation 440 may involve using one or more machine learning models to generate a combined heartbeat pattern 450 based on input heartbeat patterns.

In embodiments, source heartbeat patterns may be provided as inputs to a trained neural network, generative model, or other AI system. The AI system may be trained on a corpus of heartbeat patterns to learn statistical, temporal, and/or structural characteristics of heartbeats.

In embodiments, AI-based pattern generation 440 may produce a combined heartbeat pattern 450 that captures essential features of the source heartbeat patterns while smoothing irregularities or generating novel variations. In embodiments, the resulting combined heartbeat pattern 450 may feel more organic or natural than patterns produced by purely mathematical techniques.

In embodiments, AI-based pattern generation 440 may be performed on the backend server 130 due to computational requirements, or may be performed locally on the user device 120 or the heartbeat simulation device 110 if sufficient processing capability is available.

In embodiments, the system 100 may be configured to select one heartbeat pattern combination technique based on operational mode, initiation pathway, user preference, available resources, etc. In embodiments, the system 100 may be configured to apply multiple combination techniques sequentially or in parallel. For example, in embodiments, feature blending 420 may be applied first, followed by modulation 430, to generate a combined heartbeat pattern 450.

In embodiments, the selected technique or techniques may be stored as metadata associated with the combined heartbeat pattern 450. In embodiments, such metadata may be used to reproduce, modify, or further transform the combined heartbeat pattern at a later time.

In embodiments, the combined heartbeat pattern 450 generated by any of the techniques described herein may be stored in memory 114 of one or more heartbeat simulation devices 110. In embodiments, the combined heartbeat pattern 450 may also be stored in the heartbeat library of the companion software application 122 and optionally synchronized to the backend server 130.

In embodiments, stored combined heartbeat patterns may be reused for playback, further combination with additional heartbeat patterns, or conversion into melodies as described in subsequent sections.

In embodiments, the heartbeat pattern combination techniques illustrated in FIG. 7 are exemplary and non-limiting. In embodiments, additional combination techniques may be employed. In embodiments, the techniques described herein may be modified, combined, or substituted without departing from the scope of the disclosure.

The heartbeat pattern combination techniques described herein provide a flexible and expressive foundation for generating combined heartbeat patterns that support both tactile and auditory representations within the combined heartbeat and melody system 100.

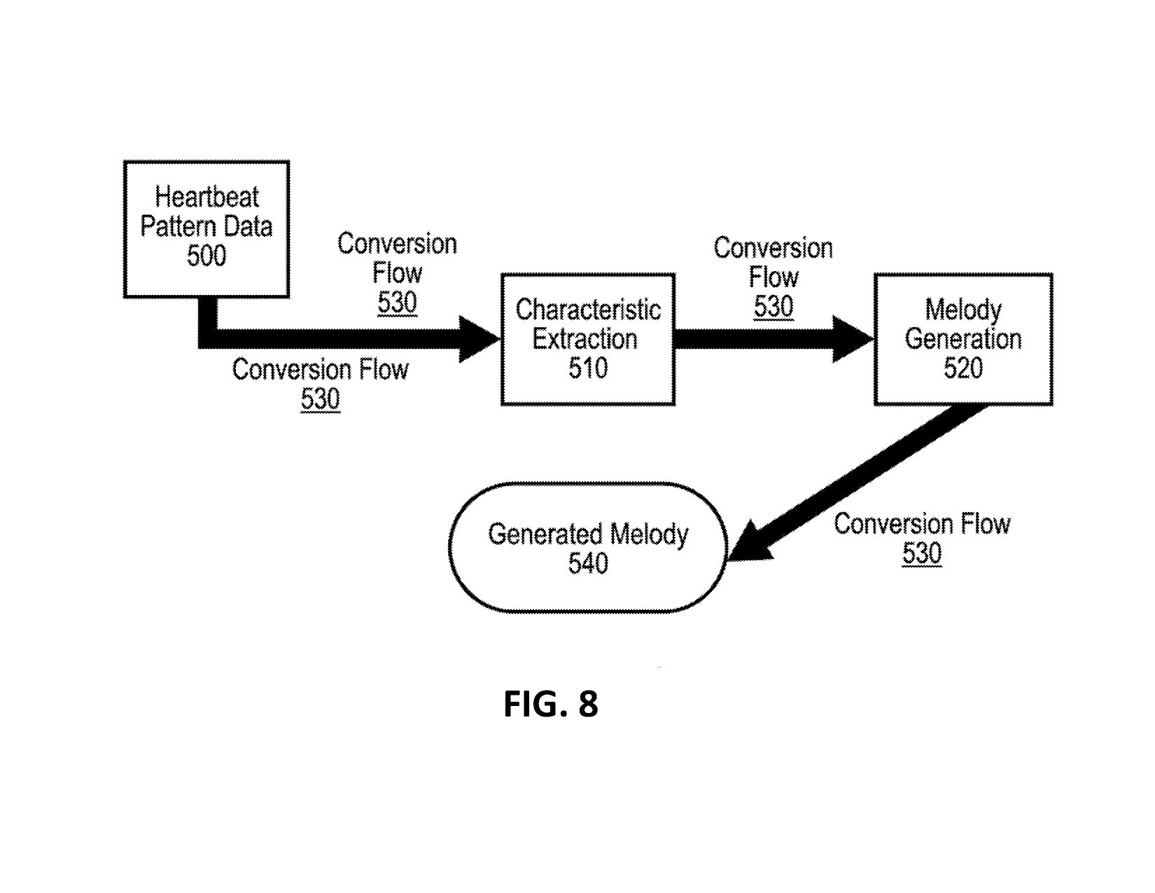

FIG. 8 is a flow diagram illustrating an embodiment of a process for converting a heartbeat pattern into a musical melody within the combined heartbeat and melody system 100 in accordance with embodiments of the present disclosure. In embodiments, the heartbeat-to-melody conversion process provides a mechanism for transforming biometric heartbeat data into an audible musical representation while preserving meaningful characteristics of the underlying heartbeat pattern. In embodiments, the heartbeat-to-melody conversion may be applied to individual heartbeat patterns, combined heartbeat patterns, or both.

In embodiments, the heartbeat-to-melody conversion described herein may be initiated by a user, initiated automatically by the heartbeat simulation device 110, and/or initiated in response to an event such as a proximity event, an attachment event, and/or a mode transition. In embodiments, the conversion process may be executed locally on the heartbeat simulation device 110, on the user device 120 executing the companion software application 122, on the backend server 130, or combinations thereof.

In embodiments, the heartbeat-to-melody conversion process may begin with heartbeat pattern data 500. In embodiments, the heartbeat pattern data 500 may correspond to an individual heartbeat pattern stored in memory 114. In embodiments, the heartbeat pattern data 500 may correspond to a combined heartbeat pattern generated as described previously. In embodiments, the heartbeat pattern data 500 may include waveform samples, beat timing information, intensity values, inter-beat intervals, or other representations of heartbeat characteristics.

In embodiments, the heartbeat pattern data 500 may be retrieved from memory 114 of the heartbeat simulation device 110, from storage associated with the companion software application 122, or from storage associated with the backend server 130. In embodiments, the heartbeat pattern data 500 may be selected by a user via the companion software application 122. In embodiments, the heartbeat pattern data 500 may be automatically selected based on the current operational mode of the heartbeat simulation device 110.

In embodiments, the heartbeat pattern data 500 may be preprocessed prior to melody generation. In embodiments, preprocessing may include filtering noise, normalizing timing or amplitude values, resampling data, or segmenting the heartbeat pattern into discrete events suitable for further analysis.

In embodiments, the heartbeat-to-melody conversion process may include a characteristic extraction stage 510. In embodiments, characteristic extraction 510 may involve analyzing the heartbeat pattern data 500 to identify one or more characteristics that may be mapped to musical parameters.

In embodiments, extracted characteristics may include heartbeat tempo, such as beats-per-minute, variability in beat timing, relative intensity of beats, duration of individual beats, and/or relationships between successive beats. In embodiments, extracted characteristics may also include higher-level descriptors, such as rhythmic regularity, complexity, and/or emotional descriptors inferred from heartbeat variability.

In embodiments, characteristic extraction 510 may be performed by the processor 112, by processing resources available to the user device 120, or by processing resources available to the backend server 130. In embodiments, the extracted characteristics may be represented as numerical parameters, feature vectors, symbolic descriptors, or combinations thereof.

In embodiments, the extracted characteristics may be stored temporarily in memory 114 or may be passed directly to the melody generation stage. In embodiments, extracted characteristics may be reused for subsequent melody generation operations or for further processing.

In embodiments, the heartbeat-to-melody conversion process may include a melody generation stage 520. In embodiments, melody generation 520 may involve generating a sequence of musical notes, tones, rhythms, and/or sound events based on the extracted heartbeat characteristics.

In embodiments, melody generation 520 may produce a melody that reflects the rhythm of the heartbeat pattern, such that the timing, pitch, rhythm, etc. of musical notes corresponds to heartbeat timing. In embodiments, melody generation 520 may produce a melody that reflects the intensity of the heartbeat pattern, such that louder or softer notes correspond to stronger or weaker beats.

In embodiments, melody generation 520 may involve mapping heartbeat characteristics to musical parameters such as pitch, duration, velocity, timbre, and/or articulation. In embodiments, melody generation 520 may incorporate constraints such as musical scales, keys, harmonic rules, and/or stylistic templates to ensure that the resulting melody is musically coherent.

In embodiments, melody generation 520 may be performed using deterministic algorithms, probabilistic algorithms, AI-based models, or combinations thereof. In embodiments, the specific techniques used for melody generation are described in further detail in subsequent sections.

In embodiments, the heartbeat-to-melody conversion may proceed through a conversion flow 530 that coordinates the stages of heartbeat pattern input, characteristic extraction, and melody generation. In embodiments, the conversion flow 530 may be implemented as a pipeline in which output of one stage serves as input to the next stage.

In embodiments, the conversion flow 530 may be configured to execute synchronously or asynchronously. In embodiments, the conversion flow 530 may execute in real time, producing a melody that is generated and played back as the heartbeat pattern is processed. In embodiments, the conversion flow 530 may execute offline, generating a melody that is stored for later playback.

In embodiments, the conversion flow 530 may be configured to adapt based on system conditions. For example, in embodiments, if processing resources are limited on the heartbeat simulation device 110, the conversion flow 530 may offload one or more stages to the user device 120 or the backend server 130. In embodiments, the companion software application 122 may coordinate such offloading.

In embodiments, the result of the heartbeat-to-melody conversion process may be a generated melody 540. In embodiments, the generated melody 540 may be represented as audio waveform data, musical note data, MIDI data, and/or another suitable representation.

In embodiments, the generated melody 540 may be stored in memory 114 of the heartbeat simulation device 110. In embodiments, the generated melody 540 may be stored in storage associated with the companion software application 122. In embodiments, the generated melody 540 may be stored in storage associated with the backend server 130 for backup or sharing.

In embodiments, the generated melody 540 may be immediately played back using the audio output generator 118 of the heartbeat simulation device 110. In embodiments, the generated melody 540 may be played back using speakers or audio output components of the user device 120. In embodiments, the generated melody 540 may be exported as a file, as described in subsequent sections.

In embodiments, the heartbeat-to-melody conversion process may interact with the operational modes described previously. For example, in embodiments, in Individual Mode 200, the generated melody 540 may be based on an individual heartbeat pattern. In embodiments, in Temporary Combined Mode 210 or Synchronized Combined Mode 220, the generated melody 540 may be based on a combined heartbeat pattern.

In embodiments, melody generation may occur automatically upon generation of a combined heartbeat pattern, or may occur only upon user request. In embodiments, melody generation may be configured to occur once, periodically, or continuously based on configuration.

In embodiments, the heartbeat-to-melody conversion process illustrated in FIG. 8 is exemplary and non-limiting. In embodiments, additional stages may be added. In embodiments, one or more stages may be omitted or combined. In embodiments, the specific mapping between heartbeat characteristics and musical parameters may vary.

The heartbeat-to-melody conversion overview described herein establishes a flexible and extensible framework for transforming heartbeat patterns into meaningful musical expressions within the combined heartbeat and melody system 100.

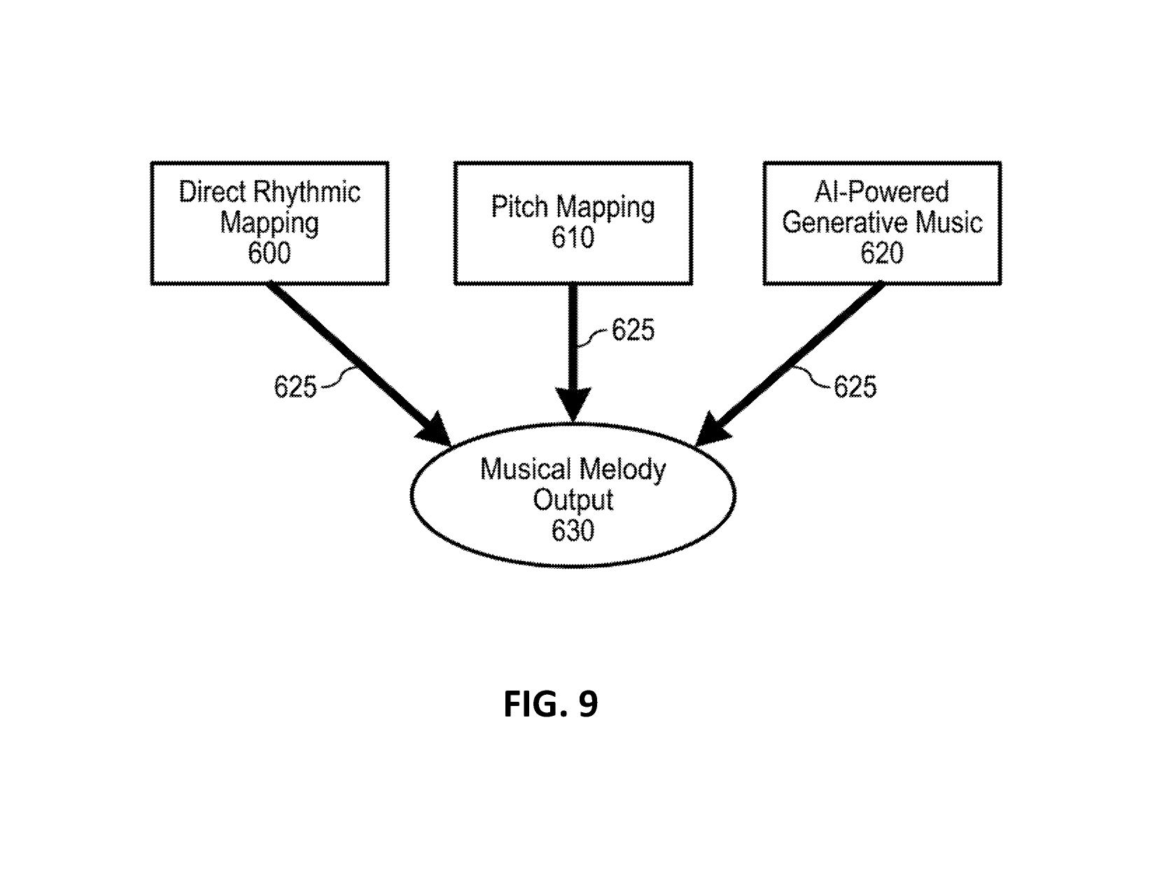

FIG. 9 is an algorithmic diagram illustrating multiple embodiments of melody generation techniques that may be employed to generate a musical melody from a heartbeat pattern within the combined heartbeat and melody system 100 in accordance with embodiments of the present disclosure. In embodiments, the melody generation techniques described herein may be applied to heartbeat patterns that are individual heartbeat patterns, combined heartbeat patterns, or both. In embodiments, the melody generation techniques may operate on heartbeat-derived characteristics extracted as described previously, and may be selected, combined, or configured based on user preferences, operational modes, processing availability, or other system conditions.

In embodiments, the melody generation techniques described herein may be implemented as software instructions executable by the processor 112 of the heartbeat simulation device 110, by processing resources available to the user device 120 executing the companion software application 122, by processing resources available to the backend server 130, or by combinations thereof. In embodiments, the selection of a particular melody generation technique may be dynamic and may change over time.

In embodiments, a melody generation technique may include direct rhythmic mapping 600. In embodiments, direct rhythmic mapping 600 may involve mapping the temporal structure of a heartbeat pattern directly to the rhythmic structure of a musical melody. In embodiments, the timing of heartbeat events, such as beats or inter-beat intervals, may directly determine the timing and duration of musical notes or sound events.

In embodiments, direct rhythmic mapping 600 may preserve the cadence of the heartbeat pattern, such that faster or slower heartbeats result in correspondingly faster or slower musical rhythms. In embodiments, direct rhythmic mapping 600 may map stronger or more intense heartbeat events to louder notes or notes with greater velocity, while weaker heartbeat events may be mapped to softer notes.

In embodiments, direct rhythmic mapping 600 may be particularly suitable for producing melodies that closely reflect the physical sensation of a heartbeat pattern. In embodiments, direct rhythmic mapping 600 may be computationally efficient and may be suitable for real-time melody generation on the heartbeat simulation device 110.

In embodiments, the processor 112 may be configured to apply quantization or smoothing to the rhythm produced by direct rhythmic mapping 600 to ensure musical coherence while still preserving the underlying heartbeat rhythm.

In embodiments, another melody generation technique may include pitch mapping 610. In embodiments, pitch mapping 610 may involve mapping one or more extracted heartbeat characteristics to musical pitch values. In embodiments, heartbeat tempo, variability, intensity, or other features may be used to determine pitch selection.

In embodiments, pitch mapping 610 may involve mapping heartbeat characteristics to a predefined musical scale or key. In embodiments, such mapping may ensure that the resulting melody remains harmonically consistent. In embodiments, pitch mapping 610 may involve selecting notes from a scale based on heartbeat-derived parameters, such as mapping faster heartbeats to higher pitches or mapping stronger beats to emphasized notes.

In embodiments, pitch mapping 610 may operate in conjunction with direct rhythmic mapping 600, such that rhythm is derived from heartbeat timing while pitch is derived from heartbeat characteristics. In embodiments, pitch mapping 610 may also operate independently, such that rhythm is determined by musical rules while pitch reflects heartbeat features.

In embodiments, pitch mapping 610 parameters may be configurable, allowing selection of musical key, scale type, pitch range, and/or transposition.

In embodiments, still another melody generation technique may include AI-powered generative music 620. In embodiments, AI-powered generative music 620 may involve using a trained machine learning model to generate a melody or song (e.g., including lyrics) based on heartbeat-derived inputs.

In embodiments, the heartbeat pattern or extracted heartbeat characteristics may be provided as input features to a neural network, generative adversarial network, transformer-based model, recurrent neural network, and/or other generative model. In embodiments, the AI model may be trained on musical data to learn relationships between rhythm, pitch, harmony, musical structure, and lyrical and voice generation.

In embodiments, AI-powered generative music 620 may generate a melody (and/or song) that is thematically inspired by the heartbeat pattern rather than directly mirroring it. In embodiments, the AI model may use the heartbeat pattern as a seed, constraint, and/or conditioning signal, allowing the generated melody to evolve while maintaining a connection to the underlying biometric data.

In embodiments, AI-powered generative music 620 may produce melodies that are more complex, expressive, or stylistically rich than those produced by simpler mapping techniques. In embodiments, AI-powered generative music 620 may be performed on the backend server 130 due to computational demands, or may be performed locally on the user device 120 or the heartbeat simulation device 110 if sufficient processing capability is available.

In embodiments, the combined heartbeat and melody system 100 may be configured to apply multiple melody generation techniques sequentially or concurrently. For example, in embodiments, direct rhythmic mapping 600 may be used to establish a rhythmic foundation, pitch mapping 610 may be used to assign notes within a musical scale, and AI-powered generative music 620 may be used to refine or embellish the melody.

In embodiments, the selection and combination of melody generation techniques may be based on user preferences specified via the companion software application 122. In embodiments, the selection may be based on operational mode, such as selecting simpler techniques for real-time playback and more complex techniques for offline generation.

In embodiments, the melody generation technique or techniques applied to generate a particular melody may be stored as metadata associated with the generated melody. In embodiments, such metadata may be used to reproduce, modify, or regenerate the melody at a later time.

In embodiments, the result of applying one or more melody generation techniques may be a musical melody output 630. In embodiments, the musical melody output 630 may be represented as a sequence of musical notes, as MIDI data, as synthesized audio waveform data, and/or as another suitable representation.

In embodiments, the musical melody output 630 may be suitable for playback using the audio output generator 118 of the heartbeat simulation device 110. In embodiments, the musical melody output 630 may be suitable for playback using the audio output capabilities of the user device 120. In embodiments, the musical melody output 630 may be exported, stored, and/or shared as described in subsequent sections.

In embodiments, melody generation techniques may be customizable. In embodiments, a user may specify parameters such as instrument type, musical style, tempo range, key, scale, or emotional tone via the companion software application 122. In embodiments, such parameters may influence how direct rhythmic mapping 600, pitch mapping 610, and/or AI-powered generative music 620 are applied.

In embodiments, customization parameters may be stored and reused across multiple melody generation operations. In embodiments, customization parameters may be associated with specific heartbeat patterns, specific combined heartbeat patterns, or specific devices.

In embodiments, the melody generation techniques illustrated in FIG. 9 are exemplary and non-limiting. In embodiments, additional techniques may be employed. In embodiments, the techniques described herein may be modified, combined, or substituted without departing from the scope of the disclosure.

The melody generation techniques described herein provide a flexible and expressive framework for transforming heartbeat patterns into musical melodies, supporting a wide range of aesthetic, emotional, and functional outcomes within the combined heartbeat and melody system 100.

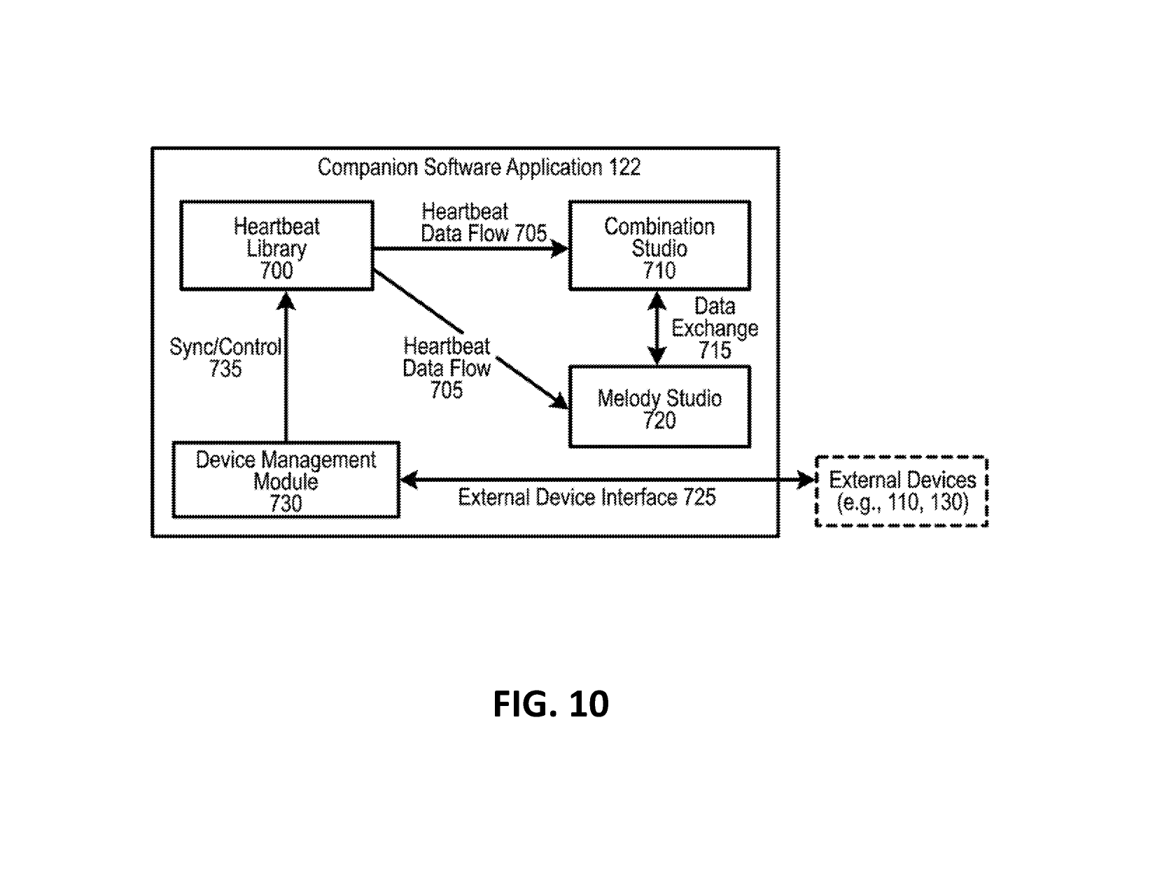

FIG. 10 is a functional block diagram illustrating an embodiment of a companion software application 122 executable on a user device 120 in accordance with embodiments of the present disclosure. In embodiments, the companion software application 122 may serve as a primary user-facing control layer for the combined heartbeat and melody system 100. In embodiments, the companion software application 122 may be configured to manage heartbeat patterns, initiate heartbeat pattern combination, initiate heartbeat-to-melody conversion, configure operational modes of one or more heartbeat simulation devices 110, and coordinate data synchronization across devices and storage locations.

In embodiments, the companion software application 122 may be implemented as a mobile application, desktop application, web-based application, or hybrid application. In embodiments, the companion software application 122 may execute on a smartphone, tablet, personal computer, and/or other computing device configured to provide user input and display capabilities. In embodiments, the companion software application 122 may communicate with one or more heartbeat simulation devices 110 via the wireless communication link 140 and may communicate with the backend server 130 via the network communication link 142.

In embodiments, the companion software application 122 may include a plurality of functional modules that cooperate to provide the overall application functionality. In embodiments, the functional modules illustrated in FIG. 10 may include a heartbeat library 700, a combination studio 710, a melody studio 720, and a device management module 730. In embodiments, each module may be implemented as a separate software component, service, or logical grouping of functionality. In embodiments, the boundaries between modules are conceptual and non-limiting, and functions may be combined or distributed differently in different implementations.

In embodiments, the companion software application 122 may be configured to act as an orchestration layer that determines when functionality is executed locally on the user device 120, when functionality is delegated to the heartbeat simulation device 110, and when functionality is offloaded to the backend server 130. In embodiments, such orchestration may be based on configuration rules, user preferences, processing capability, and/or connectivity status.

In embodiments, the heartbeat library 700 may be configured to store, organize, and/or present heartbeat patterns to a user. In embodiments, the heartbeat library 700 may include individual heartbeat patterns, combined heartbeat patterns, and/or metadata associated with such patterns. In embodiments, metadata may include identifiers, names, timestamps, source device identifiers, associated persons, operational mode indicators, and/or relationship descriptors.

In embodiments, the heartbeat library 700 may be configured to allow a user to capture new heartbeat patterns using sensors available on the user device 120 or using external sensors. In embodiments, the heartbeat library 700 may be configured to import heartbeat patterns from external sources. In embodiments, the heartbeat library 700 may be configured to synchronize heartbeat patterns with one or more heartbeat simulation devices 110.

In embodiments, the heartbeat library 700 may be configured to present heartbeat patterns in a selectable list, grid, or other organizational structure. In embodiments, a user may select one or more heartbeat patterns from the heartbeat library 700 for playback or reproduction, combination, and/or melody generation.

In embodiments, the combination studio 710 may be configured to facilitate generation of combined heartbeat patterns. In embodiments, the combination studio 710 may provide controls allowing a user to select two or more heartbeat patterns from the heartbeat library 700. In embodiments, the combination studio 710 may allow a user to select a heartbeat pattern combination technique, such as those described previously, or may automatically select a technique based on system configuration.

In embodiments, the combination studio 710 may be configured to initiate user-initiated combination 300 as described previously. In embodiments, the combination studio 710 may be configured to preview a combined heartbeat pattern prior to storage or synchronization. In embodiments, the combination studio 710 may be configured to store the resulting combined heartbeat pattern in the heartbeat library 700 and to transmit the combined heartbeat pattern to one or more heartbeat simulation devices 110.

In embodiments, the combination studio 710 may allow a user to specify whether a combined heartbeat pattern is temporary or persistent, whether it should be associated with a particular operational mode, and whether it should be synchronized across devices.

In embodiments, the melody studio 720 may be configured to facilitate heartbeat-to-melody conversion. In embodiments, the melody studio 720 may allow a user to select a heartbeat pattern, whether individual or combined, from the heartbeat library 700 and initiate melody generation.

In embodiments, the melody studio 720 may provide controls for customizing melody generation parameters, such as instrument selection, musical key, scale, tempo range, style, and/or emotional tone. In embodiments, such parameters may influence melody generation techniques applied as described previously.

In embodiments, the melody studio 720 may be configured to preview generated melodies via audio playback on the user device 120. In embodiments, the melody studio 720 may be configured to transmit generated melodies to one or more heartbeat simulation devices 110 for playback using the audio output generator 118. In embodiments, the melody studio 720 may be configured to export generated melodies as files.

In embodiments, the device management module 730 may be configured to manage pairing, configuration, and status of one or more heartbeat simulation devices 110. In embodiments, the device management module 730 may be configured to discover nearby heartbeat simulation devices 110, establish wireless communication links, and manage authentication or authorization between devices.

In embodiments, the device management module 730 may be configured to present device status information to a user, such as battery level, connectivity status, current operational mode, and storage utilization. In embodiments, the device management module 730 may be configured to allow a user to configure device-specific settings, such as default operational modes, proximity behavior, attachment behavior, and playback preferences.

In embodiments, the device management module 730 may be configured to transmit configuration data to the heartbeat simulation devices 110 and to receive status updates from such devices. In embodiments, the device management module 730 may be configured to coordinate synchronization of heartbeat patterns and melodies across multiple devices.

In embodiments, the companion software application 122 may be configured to synchronize data between the user device 120, the heartbeat simulation devices 110, and the backend server 130. In embodiments, synchronization may include heartbeat pattern data, combined heartbeat pattern data, melody data, configuration data, and metadata.

In embodiments, synchronization may occur automatically, periodically, or in response to user actions. In embodiments, synchronization may be conditional based on connectivity availability or user preferences. In embodiments, the companion software application 122 may resolve conflicts between data stored on different devices.

In embodiments, the companion software application 122 may be configured to cache data locally when connectivity is unavailable and to synchronize such data when connectivity is restored.

In embodiments, the companion software application 122 may interact with the operational modes described previously. In embodiments, the companion software application 122 may be configured to select default operational modes for heartbeat simulation devices 110. In embodiments, the companion software application 122 may be configured to override automatic mode transitions or to initiate manual mode transitions.

In embodiments, the companion software application 122 may be configured to receive notifications of mode transitions from the heartbeat simulation devices 110 and to update the user interface accordingly. In embodiments, the companion software application 122 may be configured to initiate actions, such as melody generation or combined heartbeat storage, in response to detected mode transitions.

In embodiments, the companion software application architecture illustrated in FIG. 10 is exemplary and non-limiting. In embodiments, additional modules may be included. In embodiments, one or more modules may be omitted or merged. In embodiments, functions described as performed by the companion software application 122 may be performed by other components of the system.

The companion software application architecture described herein provides a flexible and extensible control and interaction layer that enables users to engage with the combined heartbeat and melody system 100 while coordinating functionality across devices, processing resources, and storage locations.

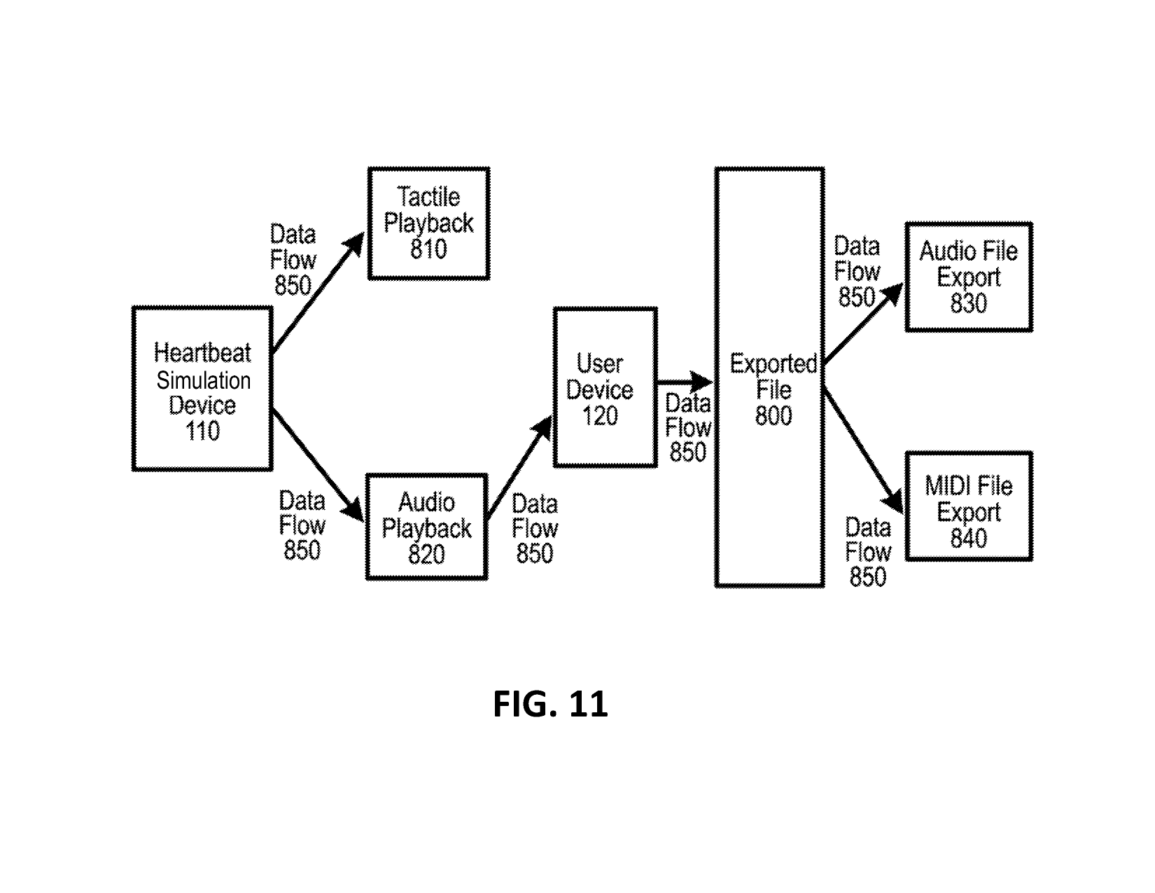

FIG. 11 is a schematic diagram illustrating embodiments for output and export pathways associated with heartbeat patterns and generated melodies within the combined heartbeat and melody system 100 in accordance with embodiments of the present disclosure. In embodiments, the system 100 may be configured to provide multiple output modalities and multiple export mechanisms, thereby allowing heartbeat patterns and melodies to be experienced, preserved, and reused in a variety of contexts. In embodiments, output and export functionality may be implemented locally on the heartbeat simulation device 110, on the user device 120 executing the companion software application 122, or through coordinated interaction between multiple components of the system.

In embodiments, output refers to real-time or near-real-time playback or rendering of a heartbeat pattern or melody, while export refers to generation of a persistent data artifact that may be stored, shared, or processed independently of the system 100. In embodiments, output and export may be treated as separate functions, such that a heartbeat pattern or melody may be output without being exported, exported without being immediately output, or both output and exported.

In embodiments, output and export functionality may apply to individual heartbeat patterns, combined heartbeat patterns, generated melodies, or combinations thereof. In embodiments, output and export behavior may be influenced by operational mode, user preferences, device capabilities, and connectivity conditions.

In embodiments, the heartbeat simulation device 110 may be configured to provide tactile playback 810 of heartbeat patterns. In embodiments, tactile playback 810 may be performed using the tactile output generator 116 under control of the processor 112. In embodiments, tactile playback 810 may include reproduction of an individual heartbeat pattern or reproduction of a combined heartbeat pattern.

In embodiments, tactile playback 810 may occur in response to detecting a user interaction (e.g., the user wrapping their hand around the heartbeat simulation device 110, squeezing the heartbeat simulation device 110, and/or pressing the heartbeat simulation device 110 against the user’s body (e.g., their chest)). In some embodiments, tactile playback 810 may occur continuously, intermittently, or in response to events such as proximity detection, attachment detection, user input, and/or scheduled playback. In embodiments, tactile playback 810 may be synchronized with audio playback or may occur independently.

In embodiments, tactile playback 810 may be configurable. For example, in embodiments, a user may configure intensity scaling, repetition frequency, playback duration, and/or timing behavior via the companion software application 122. In embodiments, tactile playback 810 may be used as a primary output modality when audio output is undesired or unavailable.

In embodiments, the heartbeat simulation device 110 may be configured to provide audio playback 820 of generated melodies. In embodiments, audio playback 820 may be performed using the audio output generator 118 under control of the processor 112. In embodiments, audio playback 820 may include playback of a melody generated from an individual heartbeat pattern or from a combined heartbeat pattern.

In embodiments, audio playback 820 may be triggered in response to detecting a user interaction (e.g., the user wrapping their hand around the heartbeat simulation device 110, squeezing the heartbeat simulation device 110, and/or pressing the heartbeat simulation device 110 against the user’s body (e.g., their chest)). In some embodiments, audio playback 820 may be triggered by user input, by mode transitions, by proximity or attachment events, or by commands received from the companion software application 122. In embodiments, audio playback 820 may be configured to operate in conjunction with tactile playback 810 or independently thereof.

In embodiments, audio playback 820 parameters such as volume, tempo scaling, looping behavior, and/or playback duration may be configurable. In embodiments, audio playback 820 may be paused, resumed, or stopped based on sensor input or received commands.

In embodiments, audio playback may also occur on the user device 120. In embodiments, generated melodies may be transmitted from the heartbeat simulation device 110 or from the backend server 130 to the companion software application 122 for playback using audio output components of the user device 120.

In embodiments, audio playback on the user device 120 may provide higher fidelity sound reproduction than the heartbeat simulation device 110. In embodiments, audio playback on the user device 120 may be used for previewing melodies prior to transferring them to the heartbeat simulation device 110 or prior to exporting them.

In embodiments, audio playback on the user device 120 may be synchronized with tactile playback on the heartbeat simulation device 110, such that a user may simultaneously feel a heartbeat pattern and hear a corresponding melody.

In embodiments, the combined heartbeat and melody system 100 may be configured to export generated melodies as one or more exported files 800. In embodiments, export may be initiated by a user via the companion software application 122. In embodiments, export may occur automatically upon melody generation or upon satisfaction of certain conditions.

In embodiments, a generated melody may be exported as an audio file export 830. In embodiments, the audio file export 830 may include formats such as WAV, MP3, AAC, or other audio formats. In embodiments, the audio file export 830 may be suitable for playback on external devices, sharing with other users, or archival storage.

In embodiments, a generated melody may be exported as a MIDI file export 840. In embodiments, the MIDI file export 840 may represent musical note and timing data corresponding to the generated melody. In embodiments, the MIDI file export 840 may be suitable for further editing, orchestration, or integration with digital audio workstations and other music production tools.

In embodiments, exported files 800 may be stored locally on the user device 120, transmitted to the backend server 130 for storage, or shared with external applications or services. In embodiments, exported files 800 may include metadata identifying the source heartbeat pattern, combination technique, melody generation technique, and associated devices.

In embodiments, FIG. 11 illustrates data flow 850 between components of the system 100 associated with output and export. In embodiments, heartbeat patterns or generated melodies may flow from memory 114 of the heartbeat simulation device 110 to the user device 120 via the wireless communication link 140. In embodiments, heartbeat patterns or generated melodies may flow from the backend server 130 to the user device 120 via the network communication link 142.

In embodiments, the companion software application 122 may coordinate data flow 850 by requesting playback, requesting export, transmitting data to devices, or storing data in local or remote storage. In embodiments, data flow 850 may be optimized to reduce latency, conserve power, or adapt to connectivity conditions.

In embodiments, data flow 850 may include acknowledgments, error handling, and retry mechanisms to ensure reliable delivery of output or exported data.

In embodiments, output and export behavior may be influenced by the operational modes described previously. For example, in embodiments, in Temporary Combined Mode 210, output may occur without export, whereas in Synchronized Combined Mode 220, output may be accompanied by persistent storage and optional export.

In embodiments, output and export behavior may be configurable via the companion software application 122. In embodiments, a user may select default output modalities, default export formats, or automatic export rules.

In embodiments, the output and export pathways illustrated in FIG. 11 are exemplary and non-limiting. In embodiments, additional output modalities or export formats may be supported. In embodiments, one or more output or export pathways may be omitted or modified.

The output and export functionality described herein ensures that heartbeat patterns and melodies generated by the combined heartbeat and melody system 100 may be experienced in real time, preserved for future use, and shared or reused beyond the immediate context of the heartbeat simulation devices.

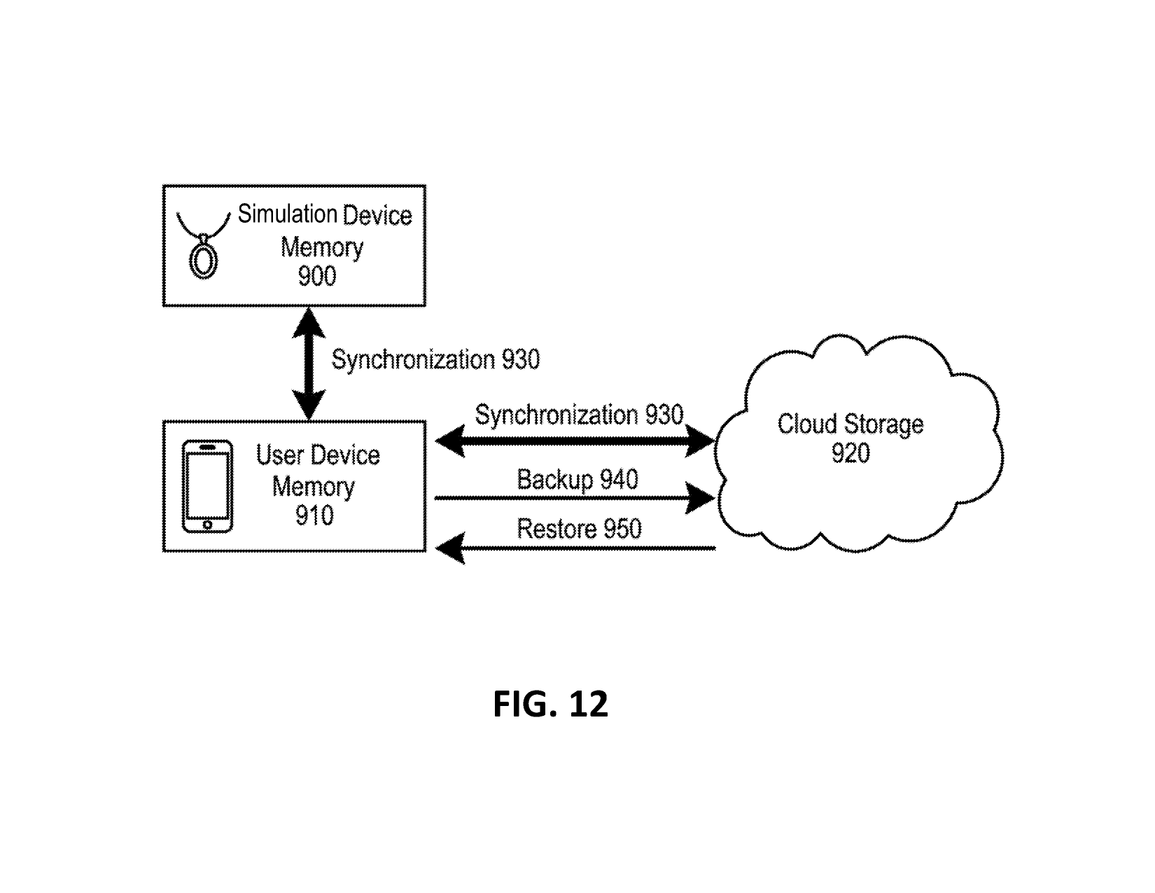

FIG. 12 is a diagram illustrating embodiments for memory management and synchronization within the combined heartbeat and melody system 100 in accordance with embodiments of the present disclosure. In embodiments, memory management and synchronization provide the underlying infrastructure that enables heartbeat patterns, combined heartbeat patterns, generated melodies, configuration data, and metadata to persist across devices, sessions, and operating conditions. In embodiments, memory management and synchronization may be distributed across the heartbeat simulation device 110, the user device 120 executing the companion software application 122, and the backend server 130.

In embodiments, the system 100 may be configured such that data may be created, modified, stored, and/or accessed at multiple locations, and synchronization mechanisms ensure consistency and availability of such data. In embodiments, synchronization may occur automatically, on demand, periodically, and/or in response to detected events, and may be configured to tolerate intermittent connectivity and partial failures.

In embodiments, the heartbeat simulation device 110 may include simulation device memory 900. In embodiments, simulation device memory 900 may correspond to the memory 114 described previously and may include non-volatile memory configured to persist data when the device is powered off.

In embodiments, simulation device memory 900 may be configured to store individual heartbeat patterns, combined heartbeat patterns, generated melodies, operational mode settings, configuration parameters, and/or metadata. In embodiments, metadata stored in simulation device memory 900 may include identifiers, timestamps, version indicators, source identifiers, and/or relationship indicators.

In embodiments, simulation device memory 900 may be configured to support rapid access by the processor 112 for real-time playback and processing. In embodiments, simulation device memory 900 may be configured to prioritize storage of certain data, such as a primary heartbeat pattern or a synchronized combined heartbeat pattern, to ensure availability even when memory capacity is limited.

In embodiments, simulation device memory 900 may be configured to store a limited subset of data relative to other storage locations. In embodiments, the companion software application 122 may manage which data is synchronized to simulation device memory 900 based on user preferences, device capacity, and operational mode.

In embodiments, the user device 120 may include user device memory 910. In embodiments, user device memory 910 may include local storage associated with the companion software application 122. In embodiments, user device memory 910 may be configured to store a more extensive library of heartbeat patterns, combined heartbeat patterns, generated melodies, and/or associated metadata than simulation device memory 900.

In embodiments, user device memory 910 may be configured to store configuration data, user preferences, operational mode settings, and/or synchronization state information. In embodiments, user device memory 910 may act as an intermediary storage location between simulation device memory 900 and cloud storage 920.

In embodiments, user device memory 910 may be configured to cache data when network connectivity is unavailable. In embodiments, cached data may be synchronized with cloud storage 920 when connectivity is restored.

In embodiments, the backend server 130 may provide cloud storage 920. In embodiments, cloud storage 920 may be configured to store heartbeat patterns, combined heartbeat patterns, generated melodies, configuration data, and/or metadata associated with one or more user accounts.

In embodiments, cloud storage 920 may serve as a long-term, persistent repository for data generated by the system 100. In embodiments, cloud storage 920 may be used for backup, restoration, multi-device synchronization, and/or migration between user devices.

In embodiments, cloud storage 920 may be optional. In embodiments, the system 100 may be configured to operate without cloud storage 920, relying solely on local storage at the heartbeat simulation device 110 and the user device 120.

In embodiments, synchronization 930 may include processes by which data stored in simulation device memory 900, user device memory 910, and cloud storage 920 are kept consistent. In embodiments, synchronization 930 may include uploading data from the user device 120 to cloud storage 920, downloading data from cloud storage 920 to the user device 120, and/or transmitting data between the user device 120 and the heartbeat simulation device 110.

In embodiments, synchronization 930 may be performed automatically in the background or may be initiated by a user action. In embodiments, synchronization 930 may be selective, such that only certain data is synchronized based on configuration rules.

In embodiments, synchronization 930 may include version control mechanisms to resolve conflicts when the same data is modified in multiple locations. In embodiments, conflict resolution may involve timestamp comparison, version numbers, user confirmation, or predefined priority rules.

In embodiments, the system 100 may support backup 940 of data to cloud storage 920. In embodiments, backup 940 may occur automatically at regular intervals or upon detection of certain events, such as generation of a new combined heartbeat pattern or melody.

In embodiments, backup 940 may ensure that heartbeat patterns and melodies are preserved in the event of device loss, replacement, or failure. In embodiments, backup 940 may include encryption or other security measures to protect sensitive data.

In embodiments, the system 100 may support restore 950 operations. In embodiments, restore 950 may involve retrieving data from cloud storage 920 and restoring it to user device memory 910 and optionally to simulation device memory 900. In embodiments, restore 950 may occur when a user installs the companion software application 122 on a new user device or pairs a new heartbeat simulation device 110.

In embodiments, memory management and synchronization behavior may interact with operational modes described previously. For example, in embodiments, in Synchronized Combined Mode 220, combined heartbeat patterns may be prioritized for storage in simulation device memory 900 and synchronized across devices.

In embodiments, memory management may ensure that combined heartbeat patterns designated as persistent remain available even after device separation or power cycling. In embodiments, memory management may ensure that temporary combined heartbeat patterns generated in Temporary Combined Mode 210 are not persisted beyond their intended scope.

In embodiments, the memory management and synchronization architecture illustrated in FIG. 12 is exemplary and non-limiting. In embodiments, additional storage locations may be used. In embodiments, synchronization strategies may be modified or extended.

The memory management and synchronization mechanisms described herein provide a resilient and flexible foundation that allows heartbeat patterns and melodies to persist, propagate, and remain accessible across the combined heartbeat and melody system 100.

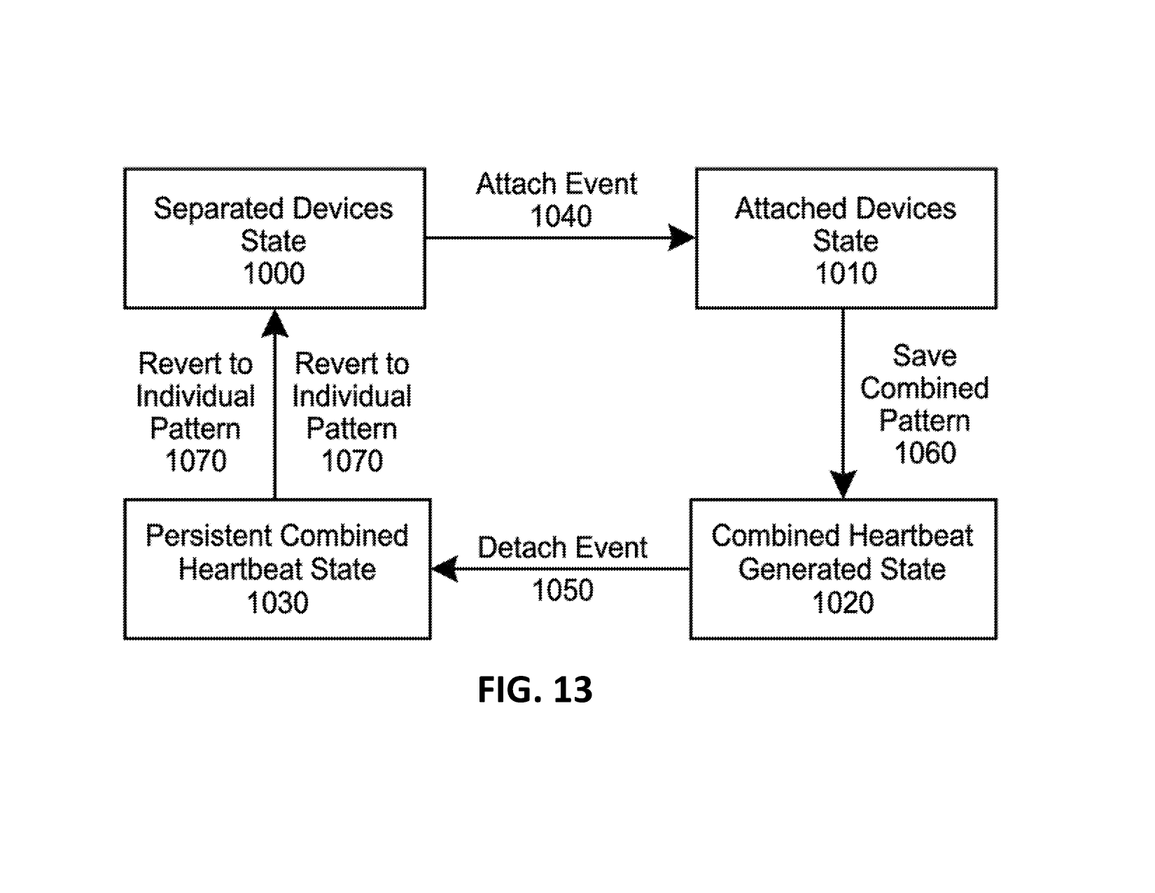

FIG. 13 is a state transition diagram illustrating embodiments of attachment and separation state transitions for heartbeat simulation devices 110 within the combined heartbeat and melody system 100 in accordance with embodiments of the present disclosure. In embodiments, the state transitions described herein define how the system responds to physical attachment and detachment events between two heartbeat simulation devices 110, and how such events influence heartbeat pattern selection, storage behavior, and output behavior. In embodiments, the state transitions may be implemented as logical state machines executed by the processor 112 and may be governed by configuration data stored in memory 114 or received from the companion software application 122.

In embodiments, the attachment and separation state transitions provide a deterministic and predictable framework that ensures consistent behavior across devices while still allowing configurability and user control.

In embodiments, when two heartbeat simulation devices 110 are not physically attached to one another, each device may be in a Separated Devices State 1000. In embodiments, in the Separated Devices State 1000, each heartbeat simulation device 110 may operate independently. In embodiments, each heartbeat simulation device 110 may output an individual heartbeat pattern or a previously stored combined heartbeat pattern depending on the current operational mode, in response to detecting a user interaction (e.g., the user wrapping their hand around the heartbeat simulation device 110, squeezing the heartbeat simulation device 110, and/or pressing the heartbeat simulation device 110 against the user’s body (e.g., their chest)).

In embodiments, while in the Separated Devices State 1000, each heartbeat simulation device 110 may continuously or intermittently monitor sensors 121 to detect proximity events or attachment events. In embodiments, proximity detection may occur without causing a transition out of the Separated Devices State 1000 unless additional conditions are satisfied.

In embodiments, configuration data may specify default behavior for the Separated Devices State 1000, such as whether individual heartbeat patterns or synchronized combined heartbeat patterns are output when devices are separated.

In embodiments, when two heartbeat simulation devices 110 are physically joined via the physical connection system 125, the devices may transition to an Attached Devices State 1010. In embodiments, detection of physical attachment may be performed using sensors 121, such as electrical contact sensors or magnetic sensors, and may generate an attachment signal received by the processor 112.

In embodiments, entry into the Attached Devices State 1010 may serve as a trigger for one or more actions. In embodiments, such actions may include initiating generation of a combined heartbeat pattern, initiating playback or reproduction of a combined heartbeat pattern, synchronizing stored data between devices, or transitioning to a different operational mode. In some embodiments, playback or reproduction of a combined heartbeat pattern may be automatic upon entry into the Attached Devices State 1010 or may be in response to detecting a user interaction (e.g., the user wrapping their hand around the heartbeat simulation device 110, squeezing the heartbeat simulation device 110, and/or pressing the heartbeat simulation device 110 against the user’s body (e.g., their chest)).

In some embodiments, the Attached Devices State 1010 may be associated with stronger assumptions of user intent than proximity-based interaction. In these embodiments, the system may enable behaviors in the Attached Devices State 1010 that may not be enabled in the Separated Devices State 1000.

In embodiments, following attachment, the system may transition to a Combined Heartbeat Generated State 1020. In embodiments, in the Combined Heartbeat Generated State 1020, a combined heartbeat pattern may be generated from individual heartbeat patterns associated with the attached devices.

In embodiments, generation of the combined heartbeat pattern may occur automatically upon entry into the Attached Devices State 1010. In embodiments, generation may occur only after confirmation from the companion software application 122 or satisfaction of configuration rules.

In embodiments, in the Combined Heartbeat Generated State 1020, the combined heartbeat pattern may be played back using tactile output, audio output, or both. In embodiments, the combined heartbeat pattern may be played on one heartbeat simulation device 110, on both heartbeat simulation devices 110 simultaneously, or each heartbeat simulation device 110 may play back a different portion of the combined heartbeat pattern. In embodiments, playback of the combined heartbeat pattern may be in response to detecting a user interaction (e.g., the user wrapping their hand around the heartbeat simulation device 110, squeezing the heartbeat simulation device 110, and/or pressing the heartbeat simulation device 110 against the user’s body (e.g., their chest)).

In embodiments, the combined heartbeat pattern generated in the Combined Heartbeat Generated State 1020 may be temporary or persistent depending on the operational mode and configuration settings.

In embodiments, the system may transition to a Persistent Combined Heartbeat State 1030. In embodiments, in the Persistent Combined Heartbeat State 1030, the combined heartbeat pattern generated during attachment may be stored in memory 114 of one or both heartbeat simulation devices 110.

In embodiments, the Persistent Combined Heartbeat State 1030 may correspond to operation in Synchronized Combined Mode 220. In embodiments, in this state, each heartbeat simulation device 110 may output the combined heartbeat pattern (e.g., concurrently or in synchronization) even after physical detachment. In embodiments, playback of the combined heartbeat pattern may be in response to detecting a user interaction (e.g., the user wrapping their hand around the heartbeat simulation device 110, squeezing the heartbeat simulation device 110, and/or pressing the heartbeat simulation device 110 against the user’s body (e.g., their chest)).

In embodiments, the transition to the Persistent Combined Heartbeat State 1030 may be triggered by a Save Combined Pattern event 1060. In embodiments, such an event may be generated automatically upon attachment or may be initiated by user input via the companion software application 122.

In embodiments, the Persistent Combined Heartbeat State 1030 may persist across power cycles, device resets, and separation events.

In embodiments, transitions between states may be triggered by events illustrated in FIG. 13. In embodiments, an Attach Event 1040 may occur when two heartbeat simulation devices 110 are physically connected. In embodiments, the Attach Event 1040 may cause a transition from the Separated Devices State 1000 to the Attached Devices State 1010.

In embodiments, a Detach Event 1050 may occur when physically attached heartbeat simulation devices 110 are separated. In embodiments, the Detach Event 1050 may cause a transition from the Attached Devices State 1010 or the Combined Heartbeat Generated State 1020 back to the Separated Devices State 1000.

In embodiments, the effect of the Detach Event 1050 may depend on the current operational mode. For example, in embodiments, in Temporary Combined Mode 210, the Detach Event 1050 may cause deletion or deactivation of the combined heartbeat pattern and reversion to individual heartbeat patterns. In embodiments, in Synchronized Combined Mode 220, the Detach Event 1050 may not affect playback of the combined heartbeat pattern.

In embodiments, the system may support a Revert to Individual Pattern event 1070. In embodiments, the Revert to Individual Pattern event 1070 may be initiated by user input via the companion software application 122. In embodiments, the Revert to Individual Pattern event 1070 may cause deletion or deactivation of a stored combined heartbeat pattern and may return each heartbeat simulation device 110 to outputting its respective individual heartbeat pattern.

In embodiments, the Revert to Individual Pattern event 1070 may be used to intentionally dissolve a persistent combined heartbeat pattern. In embodiments, such reversion may be subject to confirmation or authorization to prevent accidental loss of data.

In embodiments, state transitions illustrated in FIG. 13 may be coordinated between two heartbeat simulation devices 110. In embodiments, coordination may be achieved via direct communication through electrical contacts 127 or via short-range communication using the communication module 119.

In embodiments, coordination may ensure that both devices agree on the current state, the identity of the active heartbeat pattern, and the operational mode. In embodiments, coordination may include exchange of state identifiers, timestamps, or version indicators.

In embodiments, the attachment and separation state transitions illustrated in FIG. 13 are exemplary and non-limiting. In embodiments, additional states may be defined. In embodiments, certain states may be omitted or merged. In embodiments, transitions may be modified or conditioned on additional criteria.

The attachment and separation state transitions described herein provide a structured and reliable mechanism for managing how heartbeat simulation devices 110 respond to physical connection and separation, ensuring consistent behavior while preserving flexibility and user control within the combined heartbeat and melody system 100.

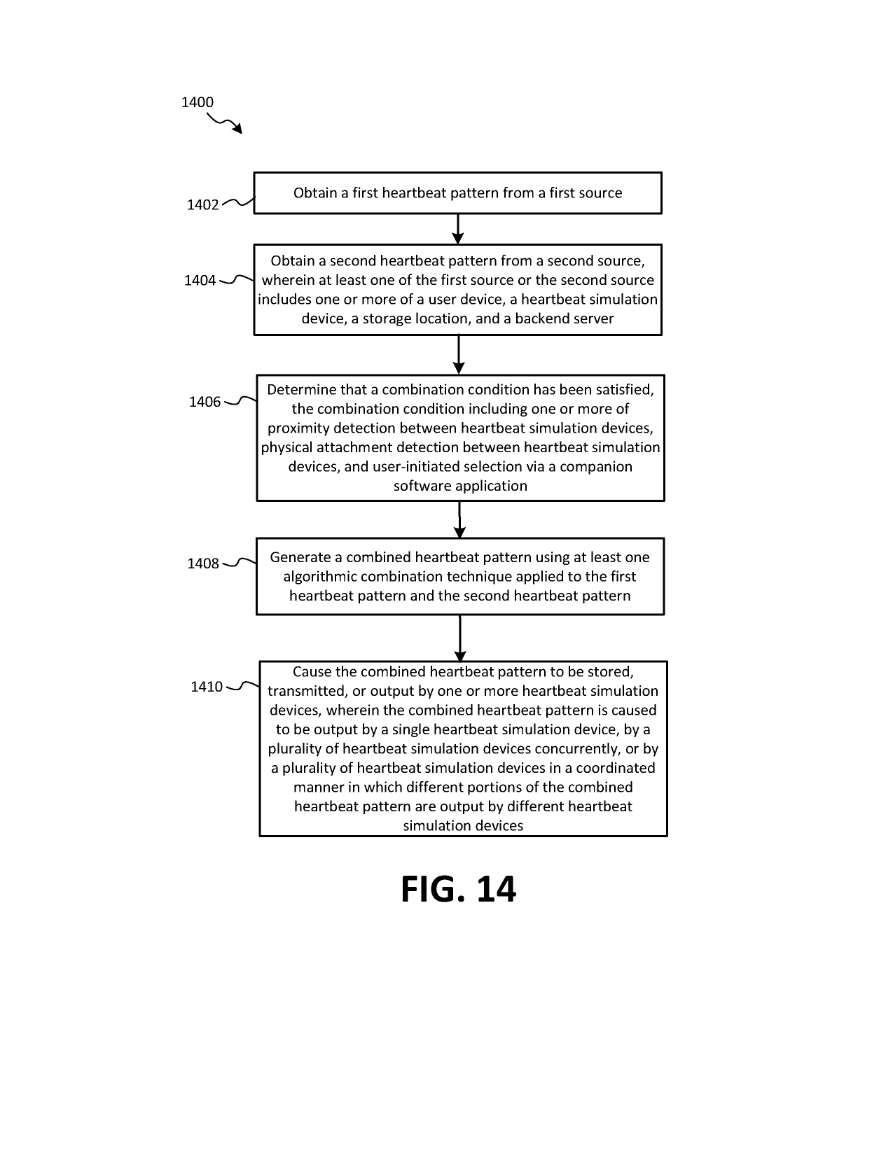

FIG. 14 shows a high-level flow diagram 1400 of operations of a method for combining heartbeat patterns associated with two or more heartbeat simulation devices in accordance with embodiments of the present disclosure. For example, the functions illustrated in the example blocks shown in FIG. 14 may be performed by system 100 as illustrated in FIG. 1 and, more particularly, by one or more heartbeat simulation devices 110, a user device executing a companion software application 122, and/or a backend server 130, according to embodiments herein. In embodiments, the operations of the method 1400 may be stored as instructions that, when executed by one or more processors, cause the one or more processors to perform the operations of the method 1400.

At block 1402, a first heartbeat pattern is obtained from a first source. In embodiments, the first source may include a heartbeat simulation device configured to store one or more heartbeat patterns. In embodiments, the first source may include a user device executing a companion software application configured to manage heartbeat patterns. In embodiments, the first source may include a storage location or a backend server configured to store heartbeat pattern data. In embodiments, obtaining the first heartbeat pattern may include retrieving the heartbeat pattern from memory, receiving the heartbeat pattern over a communication interface, or accessing the heartbeat pattern from a storage location, as described herein.

At block 1404, a second heartbeat pattern is obtained from a second source, wherein at least one of the first source or the second source includes one or more of a user device, a heartbeat simulation device, a storage location, or a backend server. In embodiments, the second heartbeat pattern may be associated with a different individual than the first heartbeat pattern. In embodiments, the second heartbeat pattern may be retrieved using operations similar to those described above with respect to block 1402. In embodiments, the first heartbeat pattern and the second heartbeat pattern may be obtained from the same source or from different sources, and the disclosure is not limited to any particular source arrangement.

At block 1406, it is determined that a combination condition has been satisfied. In embodiments, the combination condition may include detection of proximity between two or more heartbeat simulation devices. In embodiments, the combination condition may include detection of physical attachment between two or more heartbeat simulation devices. In embodiments, the combination condition may include a user-initiated selection via a companion software application executing on a user device. In embodiments, determining that the combination condition has been satisfied may include evaluating sensor data, communication signals, user input, configuration data, or combinations thereof, as described herein with reference to the system architecture and operational modes.

At block 1408, a combined heartbeat pattern is generated using at least one algorithmic combination technique applied to the first heartbeat pattern and the second heartbeat pattern. In embodiments, the algorithmic combination technique may include mathematical superposition, interleaving, feature blending, modulation, AI-based pattern generation, or combinations thereof. In embodiments, generation of the combined heartbeat pattern may be performed by a heartbeat simulation device, by a user device executing a companion software application, by a backend server, or by combinations thereof. In embodiments, generation of the combined heartbeat pattern may include producing a new heartbeat waveform, timing sequence, or pattern representation that incorporates characteristics of both the first heartbeat pattern and the second heartbeat pattern.

At block 1410, the combined heartbeat pattern is caused to be stored, transmitted, or output by one or more heartbeat simulation devices. In embodiments, the combined heartbeat pattern may be caused to be output by a single heartbeat simulation device. In embodiments, the combined heartbeat pattern may be caused to be output by a plurality of heartbeat simulation devices concurrently. In embodiments, the combined heartbeat pattern may be caused to be output by a plurality of heartbeat simulation devices in a coordinated manner in which different portions of the combined heartbeat pattern are output by different heartbeat simulation devices. In embodiments, the combined heartbeat pattern may be stored in memory of one or more heartbeat simulation devices, transmitted between devices, or synchronized across devices as described herein.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are in-tended to include within their scope such processes, machines, manufacture, compositions of matter, means, methods, or steps.

Moreover, the description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosures can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

What is claimed is:

1. A system for generating and outputting a combined heartbeat pattern, the system comprising:
a first heartbeat simulation device comprising a first output generator configured to output a heartbeat pattern;
a second heartbeat simulation device comprising a second output generator configured to output a heartbeat pattern; and
a communication arrangement configured to enable communication between the first heartbeat simulation device and the second heartbeat simulation device, wherein at least one of the first heartbeat simulation device and the second heartbeat simulation device is configured to:
detect an interaction event between the first heartbeat simulation device and the second heartbeat simulation device;
generate, in response to the interaction event, a combined heartbeat pattern based on at least the first heartbeat pattern and the second heartbeat pattern; and
cause output of the combined heartbeat pattern using one or more of the first output generator and the second output generator.

2. The system of claim 1, wherein causing the output of the combined heartbeat pattern includes automatically transmitting a control signal to a physical output component of at least one heartbeat simulation device, the control signal being configured to actuate the physical output component to produce a tangible, physically perceptible heartbeat simulation corresponding to the combined heartbeat pattern.

3. The system of claim 1, wherein the interaction event includes one or more of:
detection of proximity between the first heartbeat simulation device and the second heartbeat simulation device without physical attachment; and
detection of physical attachment between the first heartbeat simulation device and the second heartbeat simulation device.

4. The system of claim 1, wherein at least one of the first heartbeat simulation device and the second heartbeat simulation device further comprises a memory configured to store the combined heartbeat pattern.

5. The system of claim 1, wherein generation of the combined heartbeat pattern includes application of at least one algorithmic combination technique selected from the group consisting of mathematical superposition, interleaving, feature blending, modulation, and AI-based pattern generation.

6. The system of claim 1, further comprising a user device executing a companion software application, wherein the companion software application is configured to initiate generation of the combined heartbeat pattern.

7. The system of claim 6, further comprising a backend server in communication with the companion software application, wherein the backend server is configured to perform at least a portion of generation of the combined heartbeat pattern.

8. The system of claim 1, wherein at least one of the first heartbeat simulation device or the second heartbeat simulation device is further configured to convert the combined heartbeat pattern into a musical melody and to output the musical melody using an audio output generator.

9. The system of claim 1, wherein the combined heartbeat pattern is one of:
generated as a temporary combined heartbeat pattern while the interaction event persists; and
generated as a persistent combined heartbeat pattern stored for output after the interaction event ends.

10. A heartbeat simulation device comprising:
at least one processor and a memory operably coupled to the at least one processor;
a communication module configured to communicate with at least one additional heartbeat simulation device; and
a tactile output generator configured to reproduce a heartbeat pattern, wherein the memory is further configured to store processor-readable code that, when executed by the at least one processor, is configured to perform operations comprising:
generating a combined heartbeat pattern based on a heartbeat pattern stored in the memory and a heartbeat pattern received from the additional heartbeat simulation device.; and
outputting the combined heartbeat pattern, including automatically transmitting a control signal to the tactile output generator, the control signal being configured to actuate the tactile output generator to produce a tangible, physically perceptible heartbeat simulation corresponding to the combined heartbeat pattern.

11. The heartbeat simulation device of claim 10, further comprising an audio output generator configured to reproduce a melody derived from a heartbeat pattern.

12. The heartbeat simulation device of claim 10, wherein the communication module is configured to detect proximity of the additional heartbeat simulation device.

13. The heartbeat simulation device of claim 10, further comprising a physical connection system configured to physically attach the heartbeat simulation device to the additional heartbeat simulation device.

14. The heartbeat simulation device of claim 13, further comprising a sensor configured to detect physical attachment via the physical connection system.

15. The heartbeat simulation device of claim 10, wherein the operations further comprise:
generating the combined heartbeat pattern automatically upon detecting proximity or physical attachment.

16. The heartbeat simulation device of claim 10, wherein the operations further comprise:
storing the combined heartbeat pattern in the memory.

17. The heartbeat simulation device of claim 10, wherein the operations further comprise:
converting the combined heartbeat pattern into a musical melody.

18. The heartbeat simulation device of claim 10, wherein the heartbeat simulation device is configured to operate in an individual mode, a temporary combined mode, or a synchronized combined mode.

19. A method for combining heartbeat patterns associated with two or more heartbeat simulation devices, the method comprising:
obtaining a first heartbeat pattern from a first source;
obtaining a second heartbeat pattern from a second source, wherein at least one of the first source or the second source includes one or more of a user device, a heartbeat simulation device, a storage location, and a backend server;
determining that a combination condition has been satisfied, the combination condition including one or more of proximity detection between heartbeat simulation devices, physical attachment detection between heartbeat simulation devices, and user-initiated selection via a companion software application;
generating a combined heartbeat pattern using at least one algorithmic combination technique applied to the first heartbeat pattern and the second heartbeat pattern; and
causing the combined heartbeat pattern to be stored, transmitted, or output by one or more heartbeat simulation devices, wherein the combined heartbeat pattern is caused to be output by a single heartbeat simulation device, by a plurality of heartbeat simulation devices concurrently, or by the plurality of heartbeat simulation devices in a coordinated manner in which different portions of the combined heartbeat pattern are output by different heartbeat simulation devices.

20. The method of claim 19, wherein causing output of the combined heartbeat pattern includes automatically transmitting a control signal to a physical output component of at least one heartbeat simulation device, the control signal being configured to actuate the physical output component to produce a tangible, physically perceptible heartbeat simulation corresponding to the combined heartbeat pattern.
